(19) United States
(12) Patent Application Publication
(10) Pub. No.: US 2025/0331046 A1
(43) Pub. Date: Oct. 23, 2025

(54) MANAGING CONNECTIONS BETWEEN A NON-AP MLD AND A PLURALITY OF AP MLDS

(71) Applicant: SAMSUNG ELECTRONICS CO., LTD., Suwon-si (KR)

(72) Inventors: Abhishek CHATURVEDI, Bangalore (IN); Karthik Srinivasa GOPALAN, Bangalore (IN); Manasi EKKUNDI, Bangalore (IN)

(21) Appl. No.: 19/219,956

(22) Filed: May 27, 2025

Related U.S. Application Data
(63) Continuation of application No. PCT/KR2025/004212, filed on Apr. 1, 2025.

(30) Foreign Application Priority Data
Apr. 18, 2024 (IN) 202441031125
Feb. 18, 2025 (IN) 202441031125

(51) Int. Cl. H04W 76/15; H04W 24/08; H04W 88/06; H04W 88/10

(52) U.S. Cl. CPC H04W 76/15; H04W 24/08; H04W 88/06; H04W 88/10

(57) ABSTRACT

Embodiments herein provide a method and a system for managing connections between a non-AP MLD and a plurality of AP MLDs. The method includes establishing a connection with one or more of a first AP MLD and a second AP MLD in a multi-link mode. Further, the method includes determining whether KPIs of the connection between the non-AP MLD and the first AP MLD is degraded. Further, the method includes determining one or more of a first AP MLD and a second AP MLD for establishing an active data session with, when the connection is degraded. In addition, the method includes establishing the active data session between the non-AP MLD and the determined one or more of the first AP MLD and the second AP MLD, in a data aggregation mode.

### CROSS-REFERENCE TO RELATED APPLICATIONS

This application is a continuation application of International Application No. PCT/KR2025/004212 designating the United States, filed on Apr. 1, 2025 in the Korean Intellectual Property Office and claiming priority to Indian Provisional Application 20/244,1031125 filed on Apr. 18, 2024, in the Intellectual Property India Office, and India patent application Ser. No. 20/244,1031125 filed on Feb. 18, 2025, all of which are incorporated by reference herein in their entireties.

### TECHNICAL FIELD

The present disclosure is related to the field of wireless communication. More particularly, the present disclosure is related to a method and system for managing connections between a non-access point (AP) multi-link device (MLD) and a plurality of AP MLDs.

### BACKGROUND

In the Multi Link Operation (MLO) framework of Wi-Fi 7, all active links between multi-radio non-AP MLDs or stations (STAs) and a single AP MLD are restricted to that specific AP MLD. The processes for setting up, adding, modifying, or deleting these multi-link connections are managed through the Multi Link (ML) Reconfiguration procedure. For enhancing roaming capabilities in Wi-Fi 8 mobility scenarios, the agreed-upon framework encompasses several key elements. It builds on the MLO framework established in Wi-Fi 7, allowing non-collocated AP MLDs that are part of the same Extended Service Set (ESS) or Seamless Mobility Domain (SMD) to achieve quicker context access. Additionally, it facilitates the accessibility and exchange of context information for non-AP MLDs across non-collocated AP MLDs through a shared domain entity. Furthermore, it employs a secondary or additional link to enable a make-before-break roaming operation.

There are several non-roaming scenarios that can enhance an ultra-high reliability (UHR) use-case by establishing a framework that allows for the simultaneous activation of one or more additional links with a neighboring non-collocated and affiliated AP MLD, alongside the existing links on a current serving AP MLD. Such scenarios include instances where the links on the current serving AP MLD experience significant channel contention, resource limitations, or congestion. Additional scenarios include instances where there are data packet losses and retransmissions due to poor channel conditions or interference present. These challenges can also stem from hidden nodes, STAs, or non-AP MLDs. In severe cases, these conditions can lead to link loss and failures, resulting in the UHR non-AP MLD use case suffering from diminished throughput, reduced reliability, failure to meet the required QoS, and an overall negative user experience.

In existing systems, the Wi-Fi specifications lack a framework for leveraging the unused or underutilized links of neighboring non-collocated access points (APs) to enhance the key performance indicators (KPIs) of a non-AP multi-link device (MLD) that is being served by an AP MLD. This is particularly relevant in non-roaming situations, where the serving AP MLD can encounter challenges such as congestion, overload, interference, retransmissions, link loss, and link failure, ultimately leading to diminished quality of service (QoS) and a negative user experience.

Hence, a framework that makes use of the neighboring non-collocated AP MLD is desired.

### SUMMARY

A system and a method for managing connections between a non-AP MLD and a plurality of AP MLDs in a wireless communication system are provided.

A proposal outlining the sequential flow necessary to implement the ‘inter AP-MLD multi-connectivity’ feature within an Institute of Electrical and Electronics Engineers (IEEE) standard framework at the front haul and medium access control (MAC) layer is provided.

A proposal detailing the support for multi-link device feature capabilities along with the relevant information elements is provided.

A proposal for a method to evaluate links, offering serving AP MLD and non-AP MLD as two distinct evaluation options is provided.

A proposal is provided for the initiation and reconfiguration processes for the proposed feature, presenting serving AP MLD and non-AP MLD as two available options, along with associated message structures and information elements.

A proposal outlining two alternatives for a data aggregation model related to the proposed multi-connectivity feature, including suggestions for aggregation architectures and corresponding protocol stacks is provided.

One aspect of the present disclosure provides a non-access point (AP) multi-link device (MLD) in a wireless network. The non-AP MLD comprises at least one processor including processing circuitry, and memory storing instructions that, when executed by the at least one processor individually or collectively, cause the non-AP MLD to establish a connection with one or more of a first AP MLD and a second AP MLD in a multi-link mode. The instructions, when executed by the at least one processor individually or collectively, cause the non-AP MLD to determine whether one or more key performance indicators (KPIs) of the connection between the non-AP MLD and the first AP MLD indicate the connection is degraded, wherein the connection comprises a plurality of links. The instructions, when executed by the at least one processor individually or collectively, cause the non-AP MLD to determine one or more of the first AP MLD and the second AP MLD for establishing an active data session with when the connection is degraded. The instructions, when executed by the at least one processor individually or collectively, cause the non-AP MLD to establish the active data session between the non-AP MLD and the determined one or more of the first AP MLD and the second AP MLD, in a data aggregation mode.

In some embodiments, the one or more KPIs comprise one or more of an expected throughput, a reliability, a latency, a jitter, packet error rates, retransmissions, a signal strength, quality, or an interference associated with the connection between the non-AP MLD and one or more of the first AP MLD and the second AP MLD.

In some embodiments, the determining one or more of the first AP MLD and the second AP MLD for establishing the active data session with when the connection is degraded comprises generating an enhanced ML Reconfiguration Request to be transmitted to the first AP MLD, wherein the enhanced ML Reconfiguration Request comprises information about the plurality of links to be reconfigured for providing an inter AP-MLD multi-connectivity with the second AP MLD; and receiving an enhanced ML Reconfiguration Response message from the first AP MLD, wherein the enhanced ML Reconfiguration Response comprises at least one link of the plurality of links to be reconfigured for providing the inter AP-MLD multi-connectivity with the second AP MLD.

In some embodiments, the establishing the active data session between the non-AP MLD and the determined one or more of the first AP MLD and the second AP MLD comprises establishing the active data session between the non-AP MLD and the first AP MLD on a first link and a second link of the plurality of links; or extending the active data session between the non-AP MLD and both the first AP MLD and the second AP MLD on the first link, the second link, and a third link of the plurality of links.

In some embodiments, during the active data session, the first AP MLD is a primary coordinator that signals and establishes a data path with the non-AP MLD, and the second AP MLD is a secondary coordinator that establishes the data path with the non-AP MLD.

In some embodiments, the extending the active data session between the non-AP MLD and both the first AP MLD and the second AP MLD on the first link, the second link, and the third link of the plurality of links comprises: establishing the active data session between the non-AP MLD and the first AP MLD on the first link and the second link of the plurality of links; or extending the active data session between the second AP MLD on the third link of the plurality of links.

One aspect of the present disclosure provides a computer-implemented method for managing connections between a non-access point (AP) multi-link device (MLD) and a plurality of AP MLDs. The method comprises establishing, by the non-AP MLD, a connection with one or more of a first AP MLD and a second AP MLD in a multi-link mode. The method comprises determining, by the non-AP MLD, whether one or more key performance indicators (KPIs) of the connection between the non-AP MLD and the first AP MLD indicate the connection is degraded, wherein the connection comprises a plurality of links. The method comprises determining, by the non-AP MLD, one or more of the first AP MLD and the second AP MLD for establishing an active data session with when the connection is degraded. The method comprises establishing, by the non-AP MLD, the active data session between the non-AP MLD and the determined one or more of the first AP MLD and the second AP MLD, in a data aggregation mode.

In some embodiments, the one or more KPIs comprise one or more of an expected throughput, a reliability, a latency, a jitter, packet error rates, retransmissions, a signal strength, quality, or an interference associated with the connection between the non-AP MLD and one or more of the first AP MLD and the second AP MLD.

In some embodiments, the determining, by the non-AP MLD, one or more of the first AP MLD and the second AP MLD for establishing the active data session with when the connection is degraded comprises: generating, by the non-AP MLD, an enhanced ML Reconfiguration Request to be transmitted to the first AP MLD, wherein the enhanced ML Reconfiguration Request comprises information about the plurality of links to be reconfigured for providing an inter AP-MLD multi-connectivity with the second AP MLD; and receiving, by the non-AP MLD, an enhanced ML Reconfiguration Response message from the first AP MLD, wherein the enhanced ML Reconfiguration Response comprises at least one link of the plurality of links to be reconfigured for providing the inter AP-MLD multi-connectivity with the second AP MLD.

In some embodiments, the establishing, by the non-AP MLD, the active data session between the non-AP MLD and one or more of the first AP MLD and the second AP MLD comprises: performing, by the non-AP MLD: establishing, by the non-AP MLD, the active data session between the non-AP MLD and the first AP MLD on a first link and a second link of the plurality of links; or extending, by the non-AP MLD, the active data session between the non-AP MLD and both the first AP MLD and the second AP MLD on the first link, the second link, and a third link of the plurality of links.

In some embodiments, during the active data session, the first AP MLD is a primary coordinator that signals and establishes a data path with the non-AP MLD, and the second AP MLD is a secondary coordinator that establishes the data path with the non-AP MLD.

In some embodiments, the extending, by the non-AP MLD, the active data session between the non-AP MLD and both the first AP MLD and the second AP MLD on the first link, the second link, and the third link of the plurality of links comprises: performing, by the non-AP MLD: establishing, by the non-AP MLD, the active data session between the non-AP MLD and the first AP MLD on the first link and the second link of the plurality of links; or extending, by the non-AP MLD, the active data session between the second AP MLD on the third link of the plurality of links.

One aspect of the present disclosure provides a computer-implemented method for managing connections between a non-access point (AP) multi-link device (MLD) and a plurality of AP MLDs. The method includes generating a link admission request message to be transmitted to a second AP MLD of the plurality of AP MLDs. The link admission request message includes information about a plurality of links to be reconfigured with the second AP MLD based on one or more conditions. Further, the method includes receiving a link admission response message from the second AP MLD. The link admission response message includes information about whether an active data session can be established between the non-AP MLD and the second AP MLD of the plurality of AP MLDs on at least one link of the plurality of links. In addition, the method includes establishing the active data session between the non-AP MLD and the plurality of AP MLDs on at least one link of the plurality of links.

In some embodiments, the one or more conditions comprises one or more of a relocation of bad performing active links between the first AP MLD and the second AP MLD, addition of new links between the non-AP MLD and the second AP MLD, or activation of new links between non-AP MLD and the second AP MLD.

In some embodiments, the link admission request comprises non-AP MLD data session context including sequence number (SN), packet number (PN) per traffic-flow identifier (TID), block-acknowledgment agreement (BA), or security keys.

In some embodiments, the establishing, by the first AP MLD, the active data session between the non-AP MLD and the plurality of AP MLDs on at least one link of the plurality of links comprises generating, by the first AP MLD, an enhanced ML Reconfiguration message to be transmitted to the non-AP MLD, wherein the enhanced ML Reconfiguration message comprises the information about whether the active data session can be established on at least one link of the plurality of links; and receiving, by the first AP MLD, an enhanced ML Reconfiguration Complete message from the non-AP MLD upon acknowledgement that the active data session is established on at least one link of the plurality of links.

In some embodiments, the method further comprises splitting, by an upper medium access control (UMAC) layer of the first AP MLD, a plurality of data packets received from a backend distribution system (DS) (125) upon establishment of the active data session between the non-AP MLD and one or more of the first AP MLD and the second AP MLD to obtain a first split portion and a second split portion, for downlink data aggregation for uplink data. Or, the method comprises splitting, by an upper medium access control (UMAC) layer of the first AP MLD, a plurality of data packets received from a backend distribution system (DS) (125) upon establishment of the active data session between the non-AP MLD and one or more of the first AP MLD and the second AP MLD to obtain a first split portion and a second split portion, for downlink data aggregation for uplink data. Or, the method comprises forwarding, by the UMAC layer of the first AP MLD, data packets present in the second split portion to the second AP MLD on a third link of the plurality of links via a common control entity (CCE) to be transmitted by the second AP MLD towards the non-AP MLD.

The method comprises splitting, by an upper medium access control (UMAC) layer of a common control entity (CCE) of the plurality of AP MLDs, the plurality of data packets received from the backend DS upon establishment of the active data session between the non-AP MLD and one or more of the first AP MLD or the second AP MLD to obtain a first portion and a second portion, for downlink data aggregation of uplink data. The method comprises transmitting, by the upper UMAC layer of the CCE, data packets present in the first portion to a lower UMAC layer of the first AP MLD on the first link and second link of the plurality of links, and data packets present in the second portion to a lower UMAC layer of the second AP MLD on the third link of the plurality of links. A common upper UMAC functionality resides at the CCE and a lower UMAC functionality resides at each of the first AP MLD and the second AP MLD respectively.

One aspect of the present disclosure provides a first access point (AP) multi-link device (MLD) in a wireless network. The first AP MLD comprises at least one processor including processing circuitry, and memory storing instructions that, when executed by the at least one processor individually or collectively, cause the first AP MLD to generate a link admission request to be transmitted to a second AP MLD of a plurality of AP MLDs, wherein the link admission request comprises information about a plurality of links to be reconfigured with the second AP MLD based on one or more conditions. The instructions that, when executed by the at least one processor individually or collectively, cause the first AP MLD to receive a link admission response from the second AP MLD, wherein the link admission response comprises information about whether an active data session can be established between the non-AP MLD and the second AP MLD of the plurality of AP MLDs on at least one link of the plurality of links. The instructions that, when executed by the at least one processor individually or collectively, cause the first AP MLD to establish the active data session between the non-AP MLD and the plurality of AP MLDs on the at least one link of the plurality of links.

In some embodiments, the link admission request comprises non-AP MLD data session context including sequence number (SN), packet number (PN) per traffic-flow identifier (TID), block-acknowledgment agreement (BA), or security keys. One aspect of the present disclosure provides a computer-implemented method for managing connections between a non-access point (AP) multi-link device (MLD) and a plurality of AP MLDs. The method includes receiving a link admission request message from a first AP MLD of the plurality of AP MLDs. The link admission request message includes information about a plurality of links to be reconfigured with the second AP MLD. Further, the method includes determining whether an active data session can be established with the non-AP MLD on at least one link of the plurality of links mentioned in the link admission request message based on one or more conditions. In addition, the method includes generating a link admission response message to be transmitted to the first AP MLD. The link admission response message includes information about the at least one link of the plurality of links with which the active data session can be established between the non-AP MLD and the plurality of AP MLDs.

One aspect of the present disclosure includes a non-access point (AP) multi-link device (MLD) for establishing connections with a plurality of AP MLDs. The non-AP MLD includes a memory, a processor, and a non-AP MLD connection management controller communicatively coupled to the processor and the memory. The non-AP MLD connection management controller establishes a connection with one or more of a first AP MLD and a second AP MLD in a multi-link mode. Further, the non-AP MLD connection management controller determines whether one or more KPIs of the connection between the non-AP MLD and the first AP MLD is degraded. The connection comprises a plurality of links. Further, the non-AP MLD connection management controller determines one or more of the first AP MLD and the second AP MLD for establishing an active data session with, when the connection is degraded. In addition, the non-AP MLD connection management controller establishes the active data session between the non-AP MLD and one or more of the first AP MLD and the second AP MLD, in a data aggregation mode.

In some embodiments, the one or more KPIs comprise one or more of one of an expected throughput, a reliability, a latency, a jitter, packet error rates, retransmissions, a signal strength, quality, or an interference associated with the connection between the non-AP MLD and one or more of the first AP MLD and the second AP MLD.

In some embodiments, to determine one or more of the first AP MLD and the second MLD for establishing the active data session with, the non-AP MLD connection management controller is further to: generate an enhanced ML Reconfiguration Request to be transmitted to the first AP MLD, wherein the enhanced ML Reconfiguration Request comprises information about the plurality of links to be reconfigured for providing an inter AP-MLD multi-connectivity with the second AP MLD; and receive an enhanced ML Reconfiguration Response from the first AP MLD, wherein the enhanced ML Reconfiguration Response comprises at least one link of the plurality of links to be reconfigured for providing the inter AP-MLD multi-connectivity with the second AP MLD.

In some embodiments, to establish the active data session between the non-AP MLD and one or more of the first AP MLD and the second AP MLD, the non-AP MLD connection management controller is further to: establish the active data session between the non-AP MLD and the first AP MLD on a first link and a second link of the plurality of links; and extend the active data session between the non-AP MLD and both the first AP MLD and the second AP MLD on the first link, the second link, and a third link of the plurality of links.

In some embodiments, during the active data session, the first AP MLD is a primary coordinator that signals and establishes a data path with the non-AP MLD, and the second AP MLD is a secondary coordinator that establishes the data path with the non-AP MLD.

One aspect of the present disclosure includes a first access point (AP) multi-link device (MLD) for establishing connections with a non-AP MLD. The first AP MLD includes a first memory, a first processor, and a first AP MLD connection management controller communicatively coupled to the first memory and the first processor. The first AP MLD connection management controller generates a link admission request message to be transmitted to a second AP MLD of the plurality of AP MLDs. The link admission request message includes information about a plurality of links to be reconfigured with the second AP MLD based on one or more conditions. Further, the first AP MLD connection management controller receives a link admission response message from the second AP MLD. The link admission response message includes information about whether an active data session can be established between the non-AP MLD and the second AP MLD of the plurality of AP MLDs on at least one link of the plurality of links. In addition, the first AP MLD connection management controller establishes the active data session between the non-AP MLD and the plurality of AP MLDs on at least one link of the plurality of links.

One aspect of the present disclosure includes a second access point (AP) multi-link device (MLD) for establishing connections with a non-AP MLD. The second AP MLD includes a second memory, a second processor, and a second AP MLD connection management controller communicatively coupled to the second memory and the second processor. The second AP MLD connection management controller receives a link admission request message from a first AP MLD of the plurality of AP MLDs. The link admission request message includes information about a plurality of links to be reconfigured with the second AP MLD. Further, the second AP MLD connection management controller determines whether an active data session can be established with the non-AP MLD on at least one link of the plurality of links mentioned in the link admission request message based on one or more conditions. In addition, the second AP MLD connection management controller generates a link admission response message to be transmitted to the first AP MLD. The link admission response message includes information about the at least one link of the plurality of links with which the active data session can be established between the non-AP MLD and the plurality of AP MLDs.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications are made within the scope of the embodiments herein.

### BRIEF DESCRIPTION OF FIGURES

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 is a block diagram that illustrates non-collocated affiliated AP MLDs within an ESS/SMD according to prior art.

FIG. 2 is a block diagram that illustrates a schematic of a non-AP MLD implemented to carry out the disclosed subject matter according to an embodiment as disclosed herein.

FIG. 3 is a block diagram that illustrates a schematic of a first AP MLD implemented to carry out the disclosed subject matter according to an embodiment as disclosed herein.

FIG. 4 is a block diagram that illustrates a schematic of a second AP MLD implemented to carry out the disclosed subject matter according to an embodiment as disclosed herein.

FIG. 5 is a block diagram that illustrates an architecture of the proposed solution of managing connections between the non-AP MLD, the first AP MLD, and the second AP MLD according to an embodiment as disclosed herein.

FIG. 6 is a schematic diagram that illustrates an inter AP-MLD multi-connectivity feature capability support according to an embodiment as disclosed herein.

FIG. 7 is a sequence diagram that illustrates initiation of an inter AP-MLD multi-connectivity setup by the non-AP MLD according to an embodiment as disclosed herein.

FIG. 8 is a sequence diagram that illustrates initiation of the inter AP-MLD multi-connectivity setup by a serving AP MLD according to an embodiment as disclosed herein.

FIG. 9 is a schematic diagram that illustrates a message format for an enhanced ML Reconfiguration element according to an embodiment as disclosed herein.

FIG. 10A is a block diagram that illustrates an inter AP-MLD multi-connectivity aggregation model-1 according to an embodiment as disclosed herein.

FIG. 10B is a block diagram that illustrates a protocol stack of the inter AP-MLD multi-connectivity aggregation model-1 according to an embodiment as disclosed herein.

FIG. 11A is a block diagram that illustrates an inter AP-MLD multi-connectivity aggregation model-2 according to an embodiment as disclosed herein.

FIG. 11B is a block diagram that illustrates a protocol stack of the inter AP-MLD multi-connectivity aggregation model-2 according to an embodiment as disclosed herein.

FIG. 12 is a flow diagram that illustrates a method for managing connections between the non-AP MLD and the plurality of AP MLDs according to an embodiment as disclosed herein.

FIG. 13 is a flow diagram that illustrates a method for managing connections between the non-AP MLD and a first AP MLD of the plurality of AP MLDs according to an embodiment as disclosed herein.

FIG. 14 is a flow diagram that illustrates a method for managing connections between the non-AP MLD and a second AP MLD of the plurality of AP MLDs according to an embodiment as disclosed herein.

It can be noted that to the extent possible, like reference numerals have been used to represent like elements in the drawing. Further, those of ordinary skill in the art will appreciate that elements in the drawing are illustrated for simplicity and cannot have been necessarily drawn to scale. For example, the dimension of some of the elements in the drawing can be exaggerated relative to other elements to help to improve the understanding of aspects of the invention. Furthermore, the elements can have been represented in the drawing by conventional symbols, and the drawings can show only those specific details that are pertinent to the understanding the embodiments of the invention so as not to obscure the drawing with details that will be readily apparent to those of ordinary skill in the art having benefit of the description herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with a plurality of other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not to be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits, and the like, and optionally be driven by firmware and software. The circuits, for example, be embodied in a plurality of semiconductor chips, or on substrate supports such as printed circuit boards, and the like. The circuits constituting a block be implemented by dedicated hardware, or by a processor (e.g., a plurality of programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not to be limited by these terms. These terms are generally used to distinguish one element from another.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

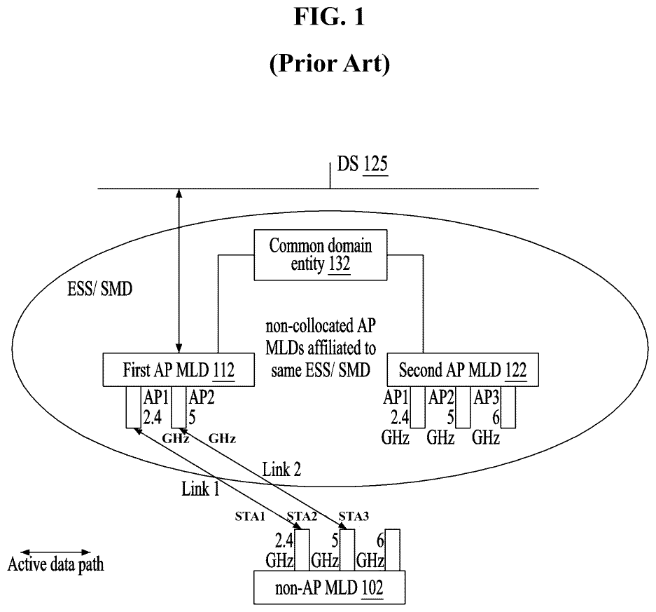

FIG. 1 is a block diagram that illustrates non-collocated affiliated Access Point (AP) multi-link devices (MLDs) within an extended service set (ESS)/Seamless Mobility Domian (SMD) according to prior art. As shown, the block diagram includes a backend distribution system (DS) (125), a non-AP MLD (102), a first AP MLD (112), and a second AP MLD (122). In one embodiment, the block diagram can include a common domain entity (CDE) (132) coupled with or otherwise linked to the first AP MLD (112) and the second MLD (122). In some embodiments, the non-AP MLD (102) is in communication with the first AP MLD (112) via link 1 and link 2. In some examples, the first AP MLD (112) and the second AP MLD (122) are in communication with each other via the common domain entity. The first AP MLD (112) can also be referred to as a serving AP MLD1 and the second AP MLD (122) can also be referred to as a neighbor AP MLD2.

Current solutions do not offer a framework within the Wi-Fi specifications for leveraging the unused or underutilized links of neighboring non-collocated access points (APs) to enhance the key performance indicators (KPIs) of a non-AP multi-link device (MLD) that is being served by an AP MLD. This is particularly relevant in non-roaming situations, where the serving AP MLD can encounter challenges such as congestion, overload, interference, retransmissions, link loss, and link failure, ultimately leading to a degraded quality of service (QoS) and a negative user experience.

As described herein, the non-AP MLD (102) is linked to the first AP MLD (112) in a multi-link configuration, with an active data session in place. In some embodiments, both the non-AP MLD (102) and the multiple AP MLDs (e.g., the first AP MLD (112) and the second MLD (122) are expected to support the proposed feature capability. In at least one embodiment, an established multi-link between the non-AP MLD (102) and the first AP MLD (112) is assessed for UHR key performance indicators (KPIs) and QoS. In some embodiments, if the evaluation meets or exceeds an expected KPI(s), the assessment will continue as planned. In other embodiments, if the evaluation does not meet or exceed the expected KPI(s), the process will gather support information for the links of a non-collocated neighbor AP MLD2 (e.g., second AP MLD (122)), which is affiliated with the same ESS/SMD. Subsequently, the procedures for initiating ‘inter AP-MLD multi-connectivity’ setup, enhanced ML Reconfiguration, and querying the second AP MLD (122) will take place. During this process, the non-AP MLD (102) will maintain an active data session while connected to both the first AP MLD (112) and the second AP MLD (122).

The description described herein introduces a feature of inter AP-MLD multi-connectivity, which stands in contrast to traditional solutions. In at least one embodiment, this feature allows for an evaluation of an active multi-link established between a non-AP MLD (102) and a first AP MLD (112) based on UHR KPIs and QoS. In at least one embodiment, if the evaluation results meet or exceed the expected KPIs, the evaluation process will continue as normal. In other embodiments, if the results fall short, the system will gather support information from a plurality of non-collocated AP MLD links that are affiliated with the same ESS/SMD. The methodology encompasses the setup of inter AP-MLD multi-connectivity, enhanced ML Reconfiguration, and Query to AP MLD2 procedures. Additionally, the non-AP MLD (102) will maintain an active data session while connected to both the first AP MLD (112) and the second AP MLD (122). Accordingly, a standardized solution architecture framework at the front haul MAC layer, facilitating data aggregation and forwarding through the utilization of links from neighboring non-collocated and affiliated AP MLDs to support UHR KPIs is described herein. In at least one embodiment, the process described herein enhances the user experience.

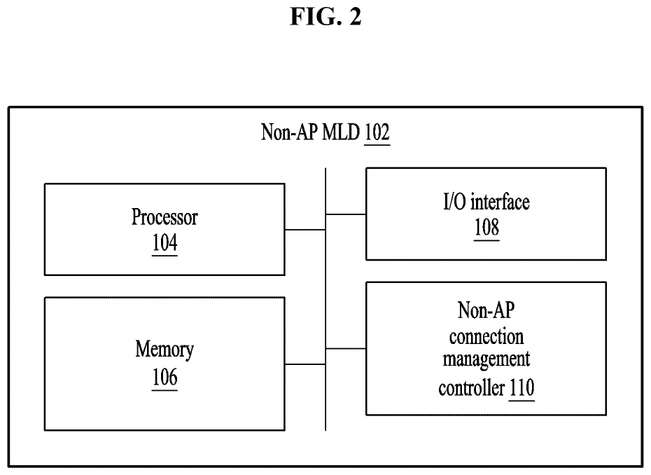

Referring now to the drawing, and more particularly to FIGS. 2 through 14 where similar reference characters denote corresponding features consistently throughout the figures, there are shown preferred embodiments.

FIG. 2 is a block diagram that illustrates a schematic of a non-AP MLD (102) implemented to carry out the disclosed subject matter according to an embodiment as disclosed herein. In at least one embodiment, the non-AP MLD (102) refers to a wireless networking device that can simultaneously manage multiple links in a Wi-Fi network. In some embodiments, the non-AP MLD (102) acts as a client device that connects with the plurality of AP MLDs in the wireless network. In some embodiments, the non-AP MLD (102) is capable of utilizing multiple frequency bands (e.g., 2.4 GHz, 5 GHz, 6 GHz, etc.) or multiple channels within a band simultaneously. In such examples, the non-AP MLD can increase data throughput, reduce latency, and improve load balancing. In some embodiments, the non-AP MLD (102) can be an example of, but not limited to, a smartphone, a tablet, a laptop, an internet of things (IOT) device, a mobile device, and the like. As shown in FIG. 2, the non-AP MLD (102) includes a processor (104), a memory (106), an input/output (I/O) interface (108), and a non-AP MLD connection management controller (110) communicatively coupled to the processor (104) and the memory (106). Each component is explained in further detail below.

In some embodiments, the processor (104) communicates with the memory (106), the I/O interface (108), and the non-AP MLD connection management controller (110). The processor (104) is configured to execute instructions stored in the memory (106) and to perform various processes. In some examples, the processor (104) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

In one embodiment, the memory (106) includes storage locations accessible through the processor (104)—e.g., the storage locations can correspond to addresses the processor is capable of accessing. The memory (106) is not limited to a volatile memory and/or a non-volatile memory. Further, the memory (106) can include a plurality of computer-readable storage media. In some embodiments, the memory (106) can include non-volatile storage elements. For example, the memory (106) can include non-volatile storage elements such as magnetic hard discs, optical discs, floppy discs, flash memories, or forms of electrically programmable memories (EPROM) or electrically erasable and programmable (EEPROM) memories.

In one embodiment, the I/O interface (108) transmits the information between the memory (106) and external peripheral devices. The peripheral devices are the input-output devices associated with the non-AP MLD (102). Further, the non-AP MLD connection management controller (110) communicates with the I/O interface (108) and the memory (106). The non-AP MLD connection management controller (110) can be communicatively coupled to the memory (106) and the processor (104). The non-AP MLD connection management controller (110) is an innovative hardware that is realized through the physical implementation of both analog and digital circuits, including logic gates, integrated circuits, microprocessors, microcontrollers, memory circuits, passive and active electronic components, as well as optical components.

In an embodiment, the non-AP MLD connection management controller (110) establishes a connection with one or more of a first AP MLD (112) and a second AP MLD (122) in a multi-link mode as described with reference to FIG. 1. In some embodiments, a multi-link mode enables the non-AP MLD (102) to send and receive data across multiple frequency bands simultaneously, effectively increasing available bandwidth. In the multi-link mode, the non-AP MLD (102) can effectively select the best link(s) for communication based on factors such as interference, congestion, signal quality, latency requirements, and the like. By combining multiple links, the non-AP MLD (102) can achieve higher aggregate throughput, enabling faster transmission and reducing delays.

In an embodiment, the non-AP MLD connection management controller (110) determines whether one or more KPIs of a connection between the non-AP MLD (102) and the first AP MLD (112) is degraded. In at least one embodiment, a degraded connection can refer to a network link or communication path experiencing reduced performance compared to its optimal state. The degraded connection can significantly impact the user experience. In some embodiments, the one or more KPIs for determining/identifying the connection degradation can include an expected throughput, a reliability, a latency, a jitter, packet error rates, retransmissions, a signal strength, quality, and an interference associated with the connection between the non-AP MLD (102) and one or more of the first AP MLD (112) and the second AP MLD (122).

In one embodiment, an expected throughput refers to an actual data transfer rate over the connection between the non-AP MLD (102) and one or more of the first AP MLD (112) and the second AP MLD (122). In such examples, a reliability refers to the ability of the connection to maintain consistent and error-free communication. In one example, a latency refers to the time taken for data packets to travel to and from the non-AP MLD (102). For instance, the latency can be expressed in milliseconds (ms). In some embodiments, a jitter refers to the variability in the latency over time, which affects the quality of real-time applications. In at least one example, a packet error rate refers to the percentage of data packets that fail to be transmitted correctly and are dropped or require retransmission. In at least one embodiment, retransmissions refer to the number of data packets that need to be retransmitted due to errors or loss. The signal strength refers to a power level of the received signal. For instance, the signal strength can be measured in decibel-milliwatts (dBM). In one example, a signal quality refers to an overall quality of the wireless signal, influenced by the interference, noise, and signal strength. Further, the interference refers to one or more external factors that disrupt the wireless signal, such as competing devices, obstacles, or environmental noise.

In an embodiment, the non-AP MLD connection management controller (110) determines one or more of the first AP MLD (112) and the second AP MLD (122) for establishing an active data session with, when the connection is degraded—e.g., the non-AP MLD connection management control 110 can establish a connection with either the first AP MLD (112) or the second AP MLD (122) when the connection is degraded. In at least one embodiment, the active data session is a live communication exchange where data packets are transmitted between the non-AP MLD (102) and one or more of the first AP MLD (112) and the second AP MLD (122). In some embodiments, the active data session involves multiple links being used simultaneously to handle the data transfer. In some embodiments, the connection remains active as long as the session has traffic flowing, leveraging features like link aggregation and redundancy for optimal performance.

In an embodiment, the non-AP MLD connection management controller (110) generates an enhanced multi-link (ML) Reconfiguration Request message to be transmitted to the first AP MLD (112). The enhanced ML Reconfiguration Request message (e.g., ML Reconfiguration* Request) includes information about a plurality of links to be reconfigured for providing an inter AP-MLD multi-connectivity with the second AP MLD (122). Inter AP-MLD multi-connectivity refers to a feature that enables the non-AP MLD (102) to establish and maintain multiple links to the first AP MLD (112) and the second AP MLD (122). Inter AP-MLD multi-connectivity enables data traffic to be duly distributed across the first AP MLD (112) and the second AP MLD (122). Distributing the data traffic can enable higher data rates and lower latency.

In an embodiment, the non-AP MLD connection management controller (110) receives an enhanced ML Reconfiguration Response message (ML Reconfiguration* Response) from the first AP MLD (112). In at least one embodiment, the enhanced ML Reconfiguration Response message includes at least one link to be reconfigured for providing the inter AP-MLD multi-connectivity with the second AP MLD (122).

In an embodiment, the non-AP MLD connection management controller (110) establishes the active data session between the non-AP MLD (102) and one or more of the first AP MLD (112) and the second AP MLD (122), in a data aggregation mode. In such embodiments, the data aggregation mode refers to a networking technique where smaller data units (for example, data packets, frames, etc.) are combined into a larger single unit for transmission over the network. The data aggregation mode is commonly used to improve network efficiency by reducing an overhead associated with sending individual data packets. Utilizing the data aggregation mode increases the overall throughput and reduces the latency.

In an embodiment, the non-AP MLD connection management controller (110) establishes the active data session between the non-AP MLD (102) and the first AP MLD (112) on a first link and a second link of the plurality of links. The active data session can also be extended between the non-AP MLD (102) and both the first AP MLD (112) and the second AP MLD (122) on the first link, the second link, and a third link of the plurality of links. In the active data session, the first AP MLD (112) is a primary coordinator that signals and establishes a data path with the non-AP MLD (102), and the second AP MLD (122) is a secondary coordinator that only establishes the data path with the non-AP MLD (102).

In at least one embodiment, the primary coordinator (e.g., first AP MLD (112)) is responsible for managing a signaling process and establishing a reliable data path with the non-AP MLD (102). In some embodiments, the signaling involves an exchange of control messages that facilitate the setup and maintenance of the communication link, ensuring that data can be transmitted efficiently and effectively between the devices. In some embodiments, the secondary coordinator (e.g. second AP MLD (122)) is specifically focused on creating a data path with the non-AP MLD (102). For example, while the secondary coordinator does not engage in the broader signaling responsibilities that the primary coordinator handles, it plays an essential part in ensuring that the data path is established and maintained, thereby supporting the overall data session. In some embodiments, the collaboration between the primary and secondary coordinators is vital for optimizing the data flow and enhancing the performance of the network.

In an embodiment, the non-AP MLD connection management controller (110) establishes the active data session between the non-AP MLD (102) and the first AP MLD (112) on the first link and the second link of the plurality of links. Also, the non-AP MLD connection management controller (110) establishes the active data session between the second AP MLD on the third link of the plurality of links.

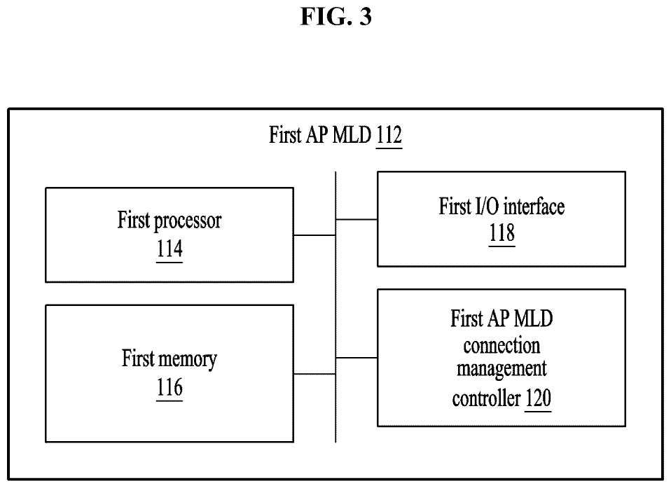

FIG. 3 is a block diagram that illustrates a schematic of a first AP MLD (112) implemented to carry out the disclosed subject matter according to an embodiment as disclosed herein. The first AP MLD (112) refers to a device or access point (AP) that supports multi-link operation (MLO). In some examples, the first AP MLD (112) is capable of managing multiple simultaneous wireless links across different frequency bands (e.g., 2.4 GHz, 5 GHz, 6 GHz, etc.). By aggregating data across multiple links, the first AP MLD (112) can significantly increase the available bandwidth and throughput by selecting a suitable link in which data is transmitted. As shown in FIG. 3, the first AP MLD (112) includes a first processor (114), a first memory (116), a first I/O interface (118), and a first AP MLD connection management controller (120) communicatively coupled to the first processor (114) and the first memory (116).

In some embodiments, the first I/O interface (118) transmits the information between the first memory (116) and external peripheral devices (not illustrated). In some embodiments, the peripheral devices are the input-output devices associated with the first AP MLD (112). Further, the first AP MLD connection management controller (120) communicates with the first I/O interface (118) and the first memory (116). In one embodiment, the first AP MLD connection management controller (120) can be communicatively coupled to the first memory (116) and the first processor (114). The first AP MLD connection management controller (120) is an innovative hardware that is realized through the physical implementation of both analog and digital circuits, including logic gates, integrated circuits, microprocessors, microcontrollers, memory circuits, passive and active electronic components, as well as optical components.

In an embodiment, the first AP MLD connection management controller (120) generates a link admission request message to be transmitted to a second AP MLD (122) of the plurality of AP MLDs. In at least one embodiment, the link admission request message includes information about a plurality of links to be reconfigured with the second AP MLD (122) based on one or more conditions. For instance, the one or more conditions include relocation of bad performing active links between the first AP MLD (112) and the second AP MLD (122), addition of new links between the non-AP (102) MLD and the second AP MLD (122), and activation of new links between non-AP MLD (102) and the second AP MLD (122).

In at least one embodiment, one of a primary condition involves the reassignment of underperforming active links currently associated with the first AP MLD (112). In some embodiments, the underperforming active links are relocated (e.g., reassigned or otherwise associated) to the second AP MLD (122) to enhance overall network efficiency and reliability. In at least one embodiment, relocating the underperforming links optimizes resource allocation and improves the quality of service (QoS) for users connected to the network. In some embodiments, in addition to the relocation of existing links, the admission request also specifies the need to establish new links between the non-AP MLD (102) and the second AP MLD (122). In at least one embodiment, introducing new links expands the network's capacity and facilitates better communication pathways, thereby enhancing the overall performance and responsiveness of the network. Further, the admission request message highlights the activation of additional links between the non-AP MLD (102) and the second AP MLD (122). In some embodiments, the activation is crucial for increasing the redundancy and resilience of the network, ensuring that there are multiple pathways for data transmission. By doing so, the network can maintain connectivity even in the event of link failures or performance degradation.

Further, the link admission request message includes non-AP MLD data session context including sequence number (SN), packet number (PN), per traffic-flow identifier (TID), block-acknowledgement agreement (BA), security keys, and the like. In some embodiments, the SN is used to uniquely identify a specific data packet within a sequence of transmitted frames. In such embodiments, the SN ensures that the receiver can correctly reassemble the data in the correct order, even if the frames arrive out of sequence. In some embodiments, the PN is a unique identifier for each packet transmitted over the network, and is tracked per TID. In at least one embodiment, the TID is used to categorize traffic flows. For example, each TID represents a specific type of traffic (for example, voice, video, data, etc.) and maps to a QoS level. TIDs help manage multi-user environments, allowing the network to prioritize traffic types.

In an embodiment, the BA refers to a negotiation between the non-AP MLD (102) and the first AP MLD (112) or the second AP MLD (122) to acknowledge multiple frames in one single acknowledgement rather than acknowledging each individual frame. In one example, the BA can assist in reducing the overhead in the wireless network, thus improving throughput and efficiency. Further, the security keys are cryptographic keys used to secure wireless communications between the non-AP MLD (102) and the first AP MLD (112) or the second AP MLD (122). In some embodiments, use of the security keys ensures the data remains confidential, authenticated, and protected from tampering.

In an embodiment, the first AP MLD connection management controller (120) receives a link admission response message from the second AP MLD (122). The link admission response message includes information about whether an active data session can be established between the non-AP MLD (102) and the second AP MLD (122) on at least one link of the plurality of links.

In an embodiment, the first AP MLD connection management controller (120) establishes the active data session between the non-AP MLD (102) and one or more of the first AP MLD (112) and the second AP MLD (122) on at least one link of the plurality of links. For establishing the active data session, the first AP MLD connection management controller (120) generates an enhanced ML Reconfiguration message to be transmitted to the non-AP MLD (102). In some examples, the enhanced ML Reconfiguration message includes the information about whether the active data session can be established on at least one link of the plurality of links. Upon generation of the enhanced ML Reconfiguration message, the first AP MLD connection management controller (120) receives an enhanced ML Reconfiguration Complete message from the non-AP MLD (102). This is received upon acknowledgement that the active data session is established on at least one link of the plurality of links between the first AP MLD (112) and the non-AP MLD (102).

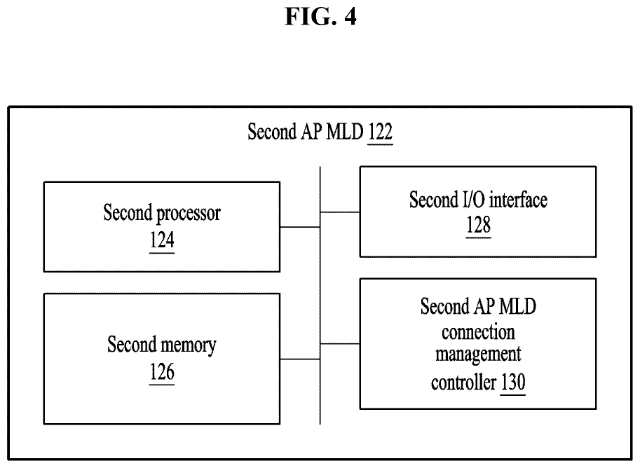

FIG. 4 is a block diagram that illustrates a schematic of a second AP MLD (122) implemented to carry out the disclosed subject matter according to an embodiment as disclosed herein. In an embodiment, the second AP MLD (122) pertains to a device or access point (AP) that facilitates multi-link operation (MLO). This second AP MLD (122) is designed to handle multiple concurrent wireless connections across various frequency bands, such as 2.4 GHz, 5 GHz, and 6 GHz. By combining data from these multiple links, the second AP MLD (122) can greatly enhance the available bandwidth and throughput by choosing the most appropriate link for data transmission. As shown in FIG. 4, the second AP MLD (122) includes a second processor (124), a second memory (126), a second I/O interface (128), and a second AP MLD connection management controller (130) communicatively coupled to the second processor (124) and the second memory (126).

In an embodiment, the second I/O interface (128) transmits the information between the second memory (126) and external peripheral devices (not illustrated). In one example, the peripheral devices are the input-output devices associated with the second AP MLD (122). Further, the second AP MLD connection management controller (130) communicates with the second I/O interface (128) and the second memory (126). In one example, the second AP MLD connection management controller (130) can be communicatively coupled to the second memory (126) and the second processor (124). The second AP MLD connection management controller (130) is an innovative hardware that is realized through the physical implementation of both analog and digital circuits, including logic gates, integrated circuits, microprocessors, microcontrollers, memory circuits, passive and active electronic components, as well as optical components.

In an embodiment, the second AP MLD connection management controller (130) receives a link admission request message from a first AP MLD (112). In such embodiments, the link admission request message includes information about a plurality of links to be reconfigured with the second AP MLD (122). Further, the second AP MLD connection management controller (130) determines whether an active data session can be established with the non-AP MLD (102) on at least one link of the plurality of links mentioned in the link admission request message based on one or more conditions. In some embodiments, the link admission request outlines specific links that the first AP MLD (112) wishes to modify or establish for enhanced connectivity and performance. This assessment is based on a set of predefined conditions, which can include factors such as network capacity, link quality, existing traffic loads, and the like.

In an embodiment, the second AP MLD connection management controller (130) generates a link admission response message to be transmitted to the first AP MLD (112). In an embodiment, the link admission response message includes information about the at least one link of the plurality of links with which the active data session can be established between the non-AP MLD (102) and the plurality of AP MLDs. In an embodiment, the response message provides feedback on the status of the requested links. Specifically, the response message details which link or links from the original request are capable of supporting an active data session between the non-AP MLD (102) and the plurality of AP MLDs involved in the communication process.

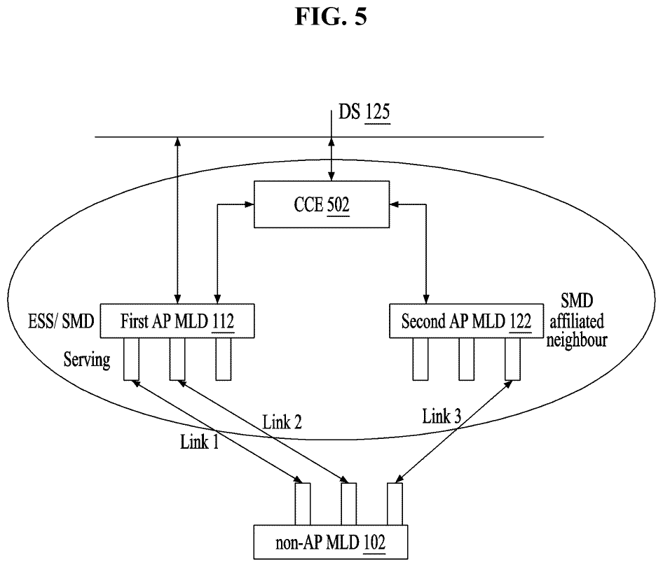

FIG. 5 is a block diagram that illustrates an architecture of the proposed solution of managing connections between a non-AP MLD (102), a first AP MLD (112), and a second AP MLD (122) according to an embodiment as disclosed herein. As shown in FIG. 5, the non-AP MLD (102) is in communication with the first AP MLD (112) via the first link and the second link, and in communication with the second AP MLD (122) via the third link. Further, the first AP MLD (112) and the second AP MLD (122) are in communication with each other via a common control entity (CCE) (502). In an embodiment, the CCE (502) has an enhanced data forwarding/aggregation/splitting functionality.

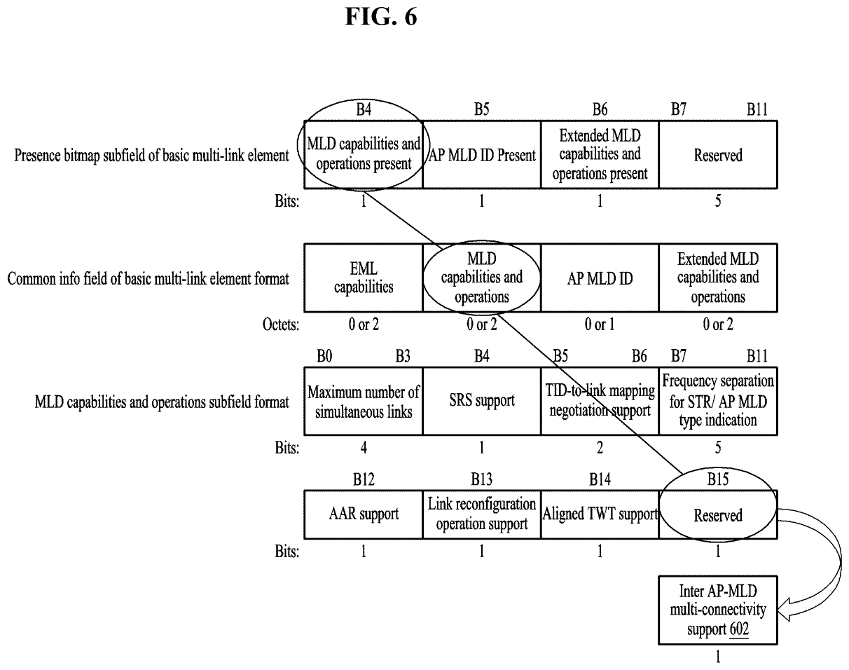

FIG. 6 is a schematic diagram that illustrates an inter AP-MLD multi-connectivity feature capability support according to an embodiment as disclosed herein. The schematic diagram shows an inter AP-MLD multi-connectivity support (602) that enables the non-AP MLD (102) to maintain active communication with the first AP MLD (112) and the second AP MLD (122) at the same time. In at least one embodiment, the schematic diagram leverages the plurality of links concurrently for higher aggregate data rates, reduced latency, and enhanced reliability. In one embodiment, the capability of the multi-link device to facilitate the ‘inter AP-MLD multi-connectivity’ feature can be signaled by defining a bit as outlined in P802.11be/D7.0 draft, specifically in section 9.4.2.322—e.g., hereby incorporated by reference in their entirety into the present disclosure as if fully set forth herein. In at least one embodiment, to indicate support for the ‘inter AP-MLD multi-connectivity’ feature, a B15 Reserved field is utilized within the MLD Capabilities format. At present, setting B15 to a value one (‘1’) signifies support for dual connectivity, indicating that links are supported across two AP MLDs only. However, this is not exhaustive, and future enhancements can introduce a bitmap that allows for connectivity support involving more than two AP MLDs. That is, the reserved field B15 can include one or more additional bits corresponding to the inter AP-MLD multi-connectivity support 602 feature. In at least one embodiment, setting a value of the reserved field B15 can indicate the device is capable of inter AP-MLD with connectivity support. In other embodiments, no value or a second value of the reserved field B15 can indicate the device is not capable of inter AP-MLD with connectivity support.

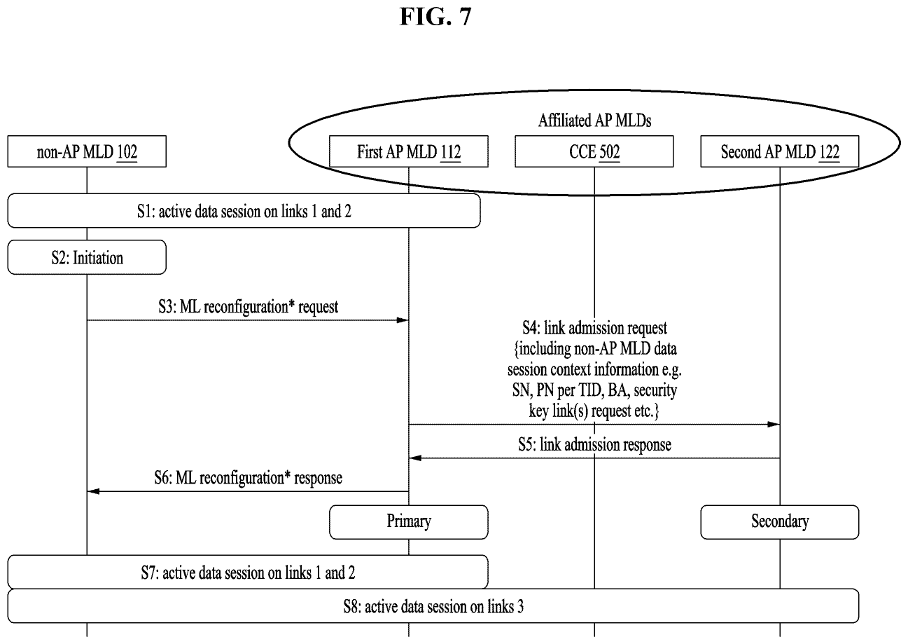

FIG. 7 is a diagram that illustrates initiation of an inter AP-MLD multi-connectivity setup by the non-AP MLD (102) according to an embodiment as disclosed herein. As illustrated in FIG. 7, the non-AP MLD (102) is in communication with affiliated AP MLDs, which includes the first AP MLD (112), the second AP MLD (122), and the CCE (502) as described with reference to FIGS. 2-5. Although one or more steps are described or shown in particular sequential order, in other embodiments the operations may be rearranged in a different order, which may include performance of multiple operations in at least partially overlapping time periods.

At step 1 (e.g., S1), an active data session is established a links 1 and 2—e.g., a non-AP MLD 102 can have an active data session on links 1 and 2 of the first AP MLD (112). In one embodiment, the non-AP MLD (102) is an ‘evaluator’ of link(s). In at least one embodiment, the non-AP MLD (102) can determine a key performance indicator (KPI) associated with the link and compare the determined KPI with an expected KPI (e.g., a threshold KPI). In at least one embodiment, the non-AP MLD (102) can determine the determined KPI is less than or worse than the expected KPI. In such embodiments, the non-AP MLD (102) can acquire the neighbor AP MLD2 link(s) information—e.g., information associated with the second AP MLD (122). In some embodiments, an assessment of ultra-high reliability (UHR) KPIs and quality of service (QoS) for active data sessions on linked connections can be performed by either the serving AP MLD1 or the non-AP MLD (102). In at least one embodiment, the evaluation can focus on individual links or a combination of them, such as link1, link2, or both link1 and link2 together. In some embodiments, the evaluation takes into account various parameters related to the KPIs, including but not limited to, throughput, reliability, latency, jitter, packet error rates, retransmissions, signal strength, quality, interference, and others. Additionally, the evaluation of ongoing data sessions on active links can be carried out periodically, with the frequency determined by the variability of KPI results and the level of mobility, which can range from stationary to walking, running, driving, or high-speed movement.

In one embodiment, the evaluator of active links, whether the first AP MLD (112) or the non-AP MLD (102), gathers information regarding the non-collocated second AP MLD (122). For the purpose of ‘inter AP-MLD multi-connectivity’ operations, only the neighboring AP MLD (e.g., second AP MLD (122)) that is part of a same ESS or SMD as the currently serving AP MLD (e.g., first AP MLD (112)) will be taken into account. In one embodiment, an affiliation of the neighboring AP MLD can be confirmed by examining its broadcasted ‘domain specific CCE medium access control (MAC) identification (ID),’ which will be identical across all affiliated AP MLDs. In some embodiments, information regarding the non-collocated AP MLD2 and its supported links is acquired through a “Beacon” frame, “Probe Response” message, or “reduced neighbor report” (RNR) neighbor information provided by the first AP MLD (112).

At step 2 (e.g., S2), the non-AP MLD (102) determines the necessary link (re) configuration to be established with the second AP MLD (122)—e.g., the non-AP MLD (102) performs an initiation. In some embodiments, the initiation can encompass various operations, including but not limited to, a transfer of underperforming active links from the first AP MLD (112) to the second AP MLD (122), as well as an introduction and activation of new links between the non-AP MLD (102) and the second AP MLD (122), and the like.

At step 3 (e.g., S3), the non-AP MLD (102) transmits an enhanced multi-link (ML) Reconfiguration Request message (ML Reconfiguration* Request) to the first AP MLD (112). In at least one embodiment, the non-AP MLD (102) transmits the enhanced ML Reconfiguration Request message to provide details about the links that need to be (re)configured in relation to the non-collocated and affiliated second AP MLD (122).

At step 4 (e.g., S4), the first AP MLD (112) can transmit a Link Admission Request to the second AP MLD (122). In at least one embodiment, the first AP MLD (112) verifies an affiliation and reachability of the second AP MLD (122) before sending the Link Admission Request. In at least one embodiment, the Link Admission Request can encompass various elements, including the non-AP MLD (102) data session context such as SN, PN per TID, BA, security keys, and more. Additionally, the link admission request can specify the links that should be established with the second AP MLD (122), taking into account the requests made by the non-AP MLD (102).

At step 5 (e.g., S5), the second AP MLD (122) assesses the availability of the links requested by the first AP MLD (112) and subsequently communicates a Link Admission Response to the first AP MLD (112). In at least one embodiment, the Link Admission Response includes details regarding links it can offer from the requested set indicated in the Link Admission Request.

At step 6 (e.g., S6), the first AP MLD (112) transmits an enhanced ML Reconfiguration Response (ML Reconfiguration* Response) to the non-AP MLD (102), providing information about the links that are to be (re)configured.

From step 7 (e.g., S7) onward, within the ‘inter AP-MLD multi-connectivity’ framework, the first AP MLD (112) can be a primary coordinator which manages both signaling and a data path. In such embodiments, the second MLD (116) can be a secondary coordinator focusing on the data path for the non-AP MLD (102).

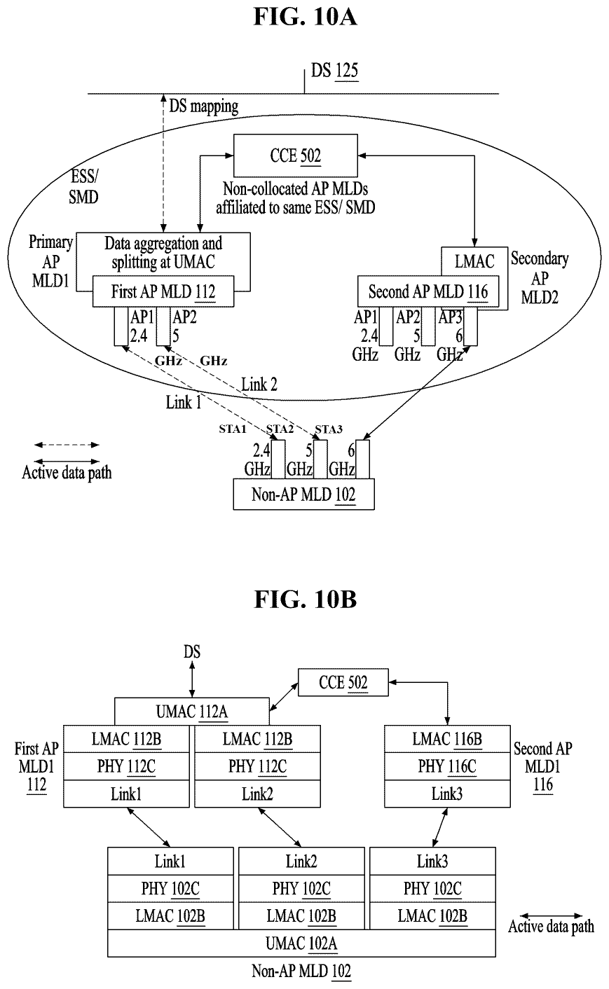

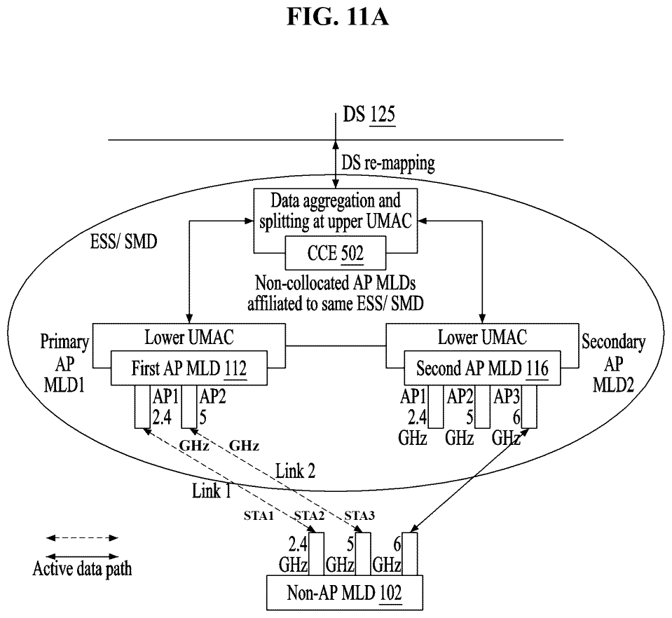

In step 8 (e.g., S8), the non-AP MLD (102) is engaged in an active data session, with connections established on both the first AP MLD (112) (links 1 and 2) and the second AP MLD (122) (link 3). The details of data aggregation model for active data paths over first AP MLD (112) and the second AP MLD (122) for the same non-AP MLD (102) context is explained in FIGS. 10-11.

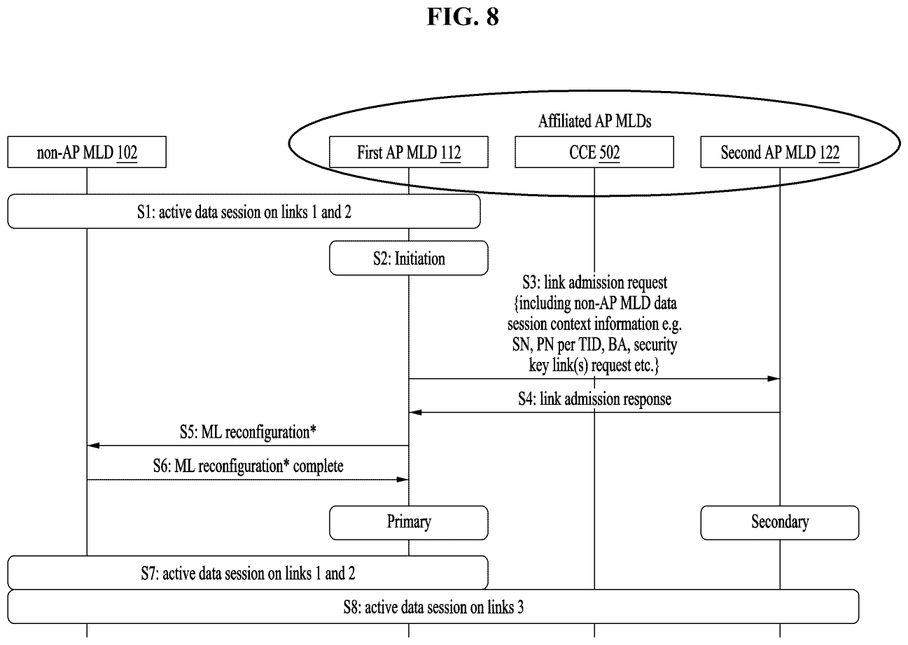

FIG. 8 is a diagram that illustrates initiation of the inter AP-MLD multi-connectivity setup by a serving AP MLD (e.g., first AP MLD (112)) according to an embodiment as disclosed herein. As illustrated in FIG. 8, a non-AP MLD (102) is in communication with affiliated AP MLDs, which includes the first AP MLD (112), the second AP MLD (122), and the CCE (502) as described with reference to FIGS. 2-5. Although one or more steps are described or shown in particular sequential order, in other embodiments the operations may be rearranged in a different order, which may include performance of multiple operations in at least partially overlapping time periods.

At step 1 (e.g., S1), the non-AP MLD (102) entity is an ‘evaluator’ of link(s). In at least one embodiment, the non-AP MLD (102) determines a KPI and compares the determined KPI with an expected KPI (e.g., a threshold KPI). In one embodiment, the non-AP MLD determines the determined KPI is less than the expected KPI and acquires the neighbor AP MLD2 link(s) information—e.g., information associated with the second AP MLD 122. In one embodiment, an assessment of UHR KPIs and QoS for active data sessions on linked connections can be conducted by either the serving AP MLD1 (e.g., first AP MLD (112) or the non-AP MLD (102)). In some embodiments, the evaluation can focus on individual links or a combination of them, such as link1, link2, or both link1 and link2 together.

In step 2 (e.g., S2), the first AP MLD (112) determines the necessary link (re)configuration to be established with the second AP MLD (122), which can encompass various operations—e.g., the first AP MLD (112) can perform an initiation. In at least one embodiment, the operations could involve a transfer of underperforming active links from the first AP MLD (112) to the second AP MLD (122), as well as an introduction and activation of new links between the non-AP MLD (102) and the second AP MLD (122), among others.

In step 3 (e.g., S3), after verifying an affiliation and accessibility of the second AP MLD (122), the first AP MLD (112) issues a Link Admission Request to the second AP MLD (122). In one embodiment, the Link Admission Request includes, but is not limited to, the non-AP MLD (102) data session context, which includes SN, PN per TID, BA, security keys, and so forth. Additionally, the Link Admission Request can specify a set of links that are to be established with the second AP MLD (122).

At step 4 (e.g., S4), the second AP MLD (122) assesses an availability of the links requested by the first AP MLD (112) and subsequently communicates a Link Admission Response to the first AP MLD (112). In at least one embodiment, the Link Admission Response includes details about the links that can be provided from the requested options.

At step 5 (e.g., S5), the first AP MLD (112) transmits an enhanced ML Reconfiguration message (ML Reconfiguration*) to the non-AP MLD (102), which contains information regarding the links that are to be (re) configured in relation to the non-collocated and affiliated second AP MLD (122).

In step 6 (e.g., S6), the non-AP MLD (102) transmits an enhanced ML Reconfiguration Complete message (ML Reconfiguration* Complete) message to the first AP MLD (112) after successfully validating and implementing the link configurations. From step 7 onward, within the framework of ‘inter AP-MLD multi-connectivity,’ the first AP MLD (112) serves as a primary coordinator, overseeing both signaling and data pathways, while the second AP MLD (122) functions as a secondary coordinator, focusing on the data path for the non-AP MLD (102).

At step 8, the non-AP MLD (102) is engaged in an active data session, with links operational on both the first AP MLD (112) (links 1 and 2) and the second AP MLD (122) (link 3). The details of data aggregation model for active data paths over the first AP MLD (112) and the second AP MLD (122) for the same non-AP MLD (102) context is explained in FIGS. 10-11.

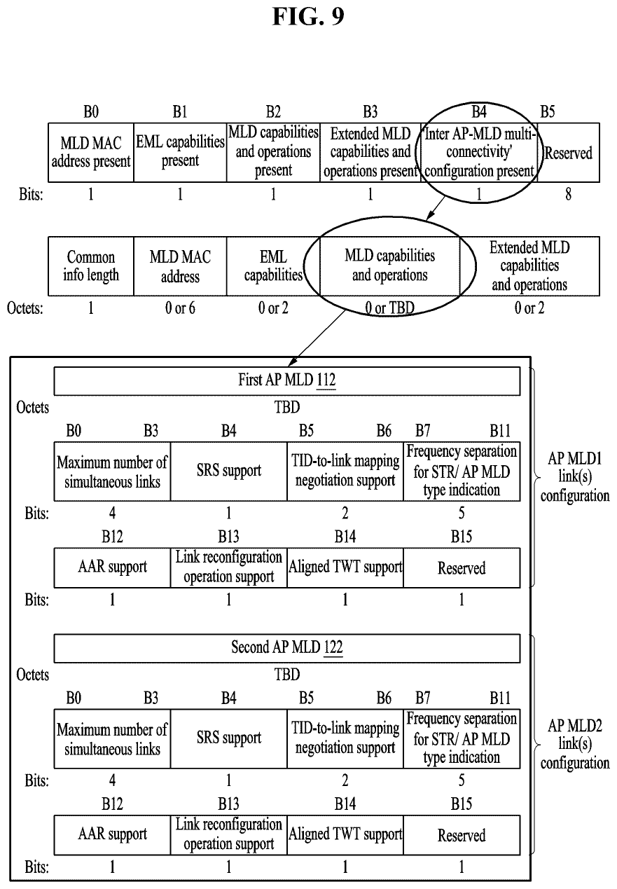

FIG. 9 is a schematic diagram that illustrates a message format for an enhanced ML Reconfiguration (ML Reconfiguration*) element according to an embodiment as disclosed herein. The ML Reconfiguration procedure, as illustrated in FIGS. 7-8, can be initiated by both the non-AP MLD (102) and the first AP MLD (112). In at least one embodiment, the ML Reconfiguration procedure is designed to configure links to function concurrently with both the serving and neighboring AP MLD in an aggregation mode. In one embodiment, the ML Reconfiguration element is utilized to signal an ML Reconfiguration operation aimed at reconfiguring the links to work with the serving and neighboring AP MLD in an aggregation mode. In at least one embodiment, the ML Reconfiguration element format is applicable to the three messages listed below:
ML Reconfiguration* Request sent by the non-AP MLD (102) to the first AP MLD1 (112) to provide recommendation for ‘inter AP-MLD multi-connectivity’ with the second AP MLD (122), to the first AP MLD (112).
ML Reconfiguration* Response sent by the first AP MLD (112) to the non-AP MLD (102) to reconfigure link(s) for operating in ‘inter AP-MLD multi-connectivity’ with the second AP MLD (122), including link(s) as confirmed by the second AP MLD (122) in the Link Admission Response.
ML Reconfiguration* sent by the first AP MLD (112) to the non-AP MLD (102) to reconfigure link(s) for operating in ‘inter AP-MLD multi-connectivity’ with the second AP MLD (122), including link(s) as confirmed by the second AP MLD (122) in the Link Admission Response.

As illustrated in FIG. 9 and in accordance with the Wi-Fi 7 standard draft, section 9.4.2.322, the reserved bit B4 in the presence bitmap can signify the existence of an ‘inter AP-MLD multi-connectivity’ configuration. For a UHR multi-link device that supports this proposed feature, if B4 is set to 1, the size of the ‘MLD Capabilities and Operations’ field will be determined (TBD) in bytes. The TBD bytes will encompass TBD bytes allocated for the IDs of both serving and neighboring AP MLDs, along with 2 bytes for each AP MLD's link configuration, based on the existing format.

In an embodiment, the message format for Link Admission Request is given as:
non-AP MLD data session context information
   Sequence Number (SN)
   Packet number per traffic flow identification (PN per TID)
   Block acknowledgement agreement information (BA agreement)
   Security key construct for faster authentication/association
Link information Requested (e.g., at a given frequency, for example 2.4 GHz, 5 GHz, 6 GHz, etc.)
   Link(s) requested bitmap
      Value ‘1’ indicates link info is requested
      Value ‘0’ indicates link info is not requested
   Link(s) information requested
      Load condition per link
      Signal strength per link
      Signal quality per link
Reserved Bits for Future Use

In an embodiment, the message format for Link Admission Response is given as:
non-AP MLD context accept—acknowledgement
Available link(s) information of the Requested ones (e.g., at a given frequency, for example 2.4 GHz, 5 GHz, 6 GHz, etc.)
   Link(s) available bitmap
      Value ‘1’ indicates link is available
      Value ‘0’ indicates link is not available
   Available Link(s) information
      Link1 e.g., 2.4 GHz (Load condition of link1, signal strength of link1, signal quality of link1).
      Link2 e.g., 5 GHz (Load condition of link2, signal strength of link2, signal quality of link2.
      Etc, for each link (Load Condition per link, signal strength per link, signal quality per link)
Reserved Bits for Future Use

FIG. 10A is a block diagram that illustrates an inter AP-MLD multi-connectivity aggregation model (e.g., a first model, model-1) according to an embodiment as disclosed herein. As illustrated in FIG. 10A, the non-AP MLD (102) is in communication with the first AP MLD (112) and the second AP MLD (122) via links. The first AP MLD (112) and the second AP MLD (122) are in communication with each other via the CCE (502). The CCE (502) serves as a data forwarding interface for the transmission of split downlink and uplink packets between the first AP MLD (112) and the second AP MLD (122). In some embodiments, the CCE (502) is implemented within a backend distribution system (DS) (125) or directly within the first AP MLD (112). In some embodiments, the structure of FIG. 10A will enhance a first category of seamless roaming architecture proposals and provide benefits through a cohesive framework for the interworking of non-collocated AP MLDs.

FIG. 10B is a block diagram that illustrates a protocol stack of an inter AP-MLD multi-connectivity aggregation model (e.g., a first model, model-1) according to an embodiment as disclosed herein. As shown, the non-AP MLD (102) includes an upper medium access control (UMAC) (102A) layer and three links (link 1, link 2, and link 3). Each link includes a lower (LMAC) (102B) layer and a physical (PHY) (102C) layer below. In some embodiments, the first AP MLD (112) includes a first link (link 1) and a second link (link 2). The first link (link 1) and the second link (link 2) each have a LMAC (112B) layer and a PHY (112C) layer below. Further, the second AP MLD (122) includes a third link (link 3). The third link (link 3) has a PHY (116C) layer below it.

In an embodiment, a UMAC (102A) layer focuses on logical of high-level MAC operations, ensuring efficient and secure data transfer. In some embodiments, an LMAC (102B, 112B, 116B) layer bridges the gap between logical MAC operations and physical transmission/reception processes. Further, the PHY (102C, 112C, 116C) layer is the lowest layer and is responsible for translating digital data into electromagnetic signals for wireless communication.

In an embodiment, the first AP MLD (112) serves as a main coordinator for all signaling frames exchanged with the non-AP MLD (102). Consequently, an association of the non-AP MLD (102) is still established in relation to the first AP MLD (112). In at least one embodiment, the mapping of the backend distribution system (DS) (125) remains consistent, ensuring that all downlink (DL) and uplink (UL) data packets continue to be routed to and from the DS (125) and the first AP MLD (112). In some embodiments, the DL data from the DS can be divided at the UMAC (112A) layer of the first AP MLD (112). A portion of this data is transmitted to the non-AP MLD (102) through the LMAC (112B) layer of the first AP MLD (112) via primary links 1 and 2, while the remainder is sent to the non-AP MLD (102) through the LMAC (116C) layer of the second AP MLD (122) via secondary link 3. Such embodiments aim to optimize link and channel utilization, facilitating the rapid delivery of the majority of DL data to the non-AP MLD (102).

In an embodiment, data designated for link 3 is transmitted to the second AP MLD (122) through the CCE (502), which primarily facilitates downlink and uplink data forwarding within this framework. Data arriving at the non-AP MLD (102) through links 1, 2, and 3 is typically aggregated at the UMAC (102A) layer, akin to standard multi-link operations. In an embodiment, security keys employed for encryption and integrity across all three links 1, 2, and 3 remain consistent with those utilized at the first AP MLD (112) prior to the addition of the second AP MLD (122). That is, the endpoint for data aggregation continues to reside at the first AP MLD (112), serving as the primary coordinator. Additionally, the uplink data produced at the non-AP MLD (102) can also be distributed across links 1, 2, and 3 as part of the established multi-link operation. In some embodiments, all uplink data transmitted over the LMAC (116B) layer of the second AP MLD (122) via link 3 is relayed to the first AP MLD (112) through the CCE (502) and subsequently aggregated at the UMAC (112A) layer of the first AP MLD (112).

FIG. 11A is a block diagram that illustrates an inter AP-MLD multi-connectivity aggregation model (e.g., a second model, model-2) according to an embodiment as disclosed herein. As illustrated in FIG. 11A, the non-AP MLD (102) is in communication with the first AP MLD (112) and the second AP MLD (122) via links. The first AP MLD (112) and the second AP MLD (122) are in communication with each other via the CCE (502). The CCE (502) features an AP MLD (102) level connection and identification at the DS level for the purpose of data path re-mapping. In at least one embodiment, positioning the CCE (502) as a comprehensive logical entity that extends beyond AP MLDs can enhance data management capabilities. In such embodiment, the positioning of the CCE 502 facilitates an implementation of a second category within the seamless roaming architecture proposals, thereby enabling the benefits of a unified framework for the interworking of non-collocated AP MLDs.

FIG. 11B is a block diagram that illustrates a protocol stack of the inter AP-MLD multi-connectivity aggregation model (e.g., a second model, model-2) according to an embodiment as disclosed herein. In an embodiment, first AP MLD (112) serves as a main coordinator for all signaling frames exchanged with the non-AP MLD (102). In such embodiments, the association of the non-AP MLD (102) is established in relation to the first AP MLD (112). In one embodiment, the DS connection is redirected to the CCE (502), which is identified by a CCE MAC ID within an ESS/SMD, and all downlink (DL) and uplink (UL) data packets are now directed to and from the DS and the CCE (502). In one embodiment, DL data received from the DS can be divided at an upper UMAC (502A) layer of the CCE (502), with a portion being transmitted to the non-AP MLD (102) through a lower UMAC (112D) layer of the first AP MLD (112), which aggregates LMAC links 1 and 2. The remaining data is sent to the non-AP MLD (102) via a lower UMAC (116D) layer of the second AP MLD (122), which aggregates LMAC link 3. In an embodiment, the structure illustrated in FIG. 11B optimizes link and channel usage, ensuring that the majority of DL data reaches the non-AP MLD (102) promptly.

In an embodiment, data received at the non-AP MLD (102) through links 1, 2, and 3 is typically aggregated at the UMAC (102A) layer, following standard multi-link operations. In an embodiment, security keys utilized for encryption and integrity across these links are reconfigured, as the data split/aggregation entity has been adjusted to the CCE (502) along with DS remapping. In such embodiments, newly configured keys are communicated to the non-AP MLD (102) via the enhanced ML Reconfiguration message sent through the primary coordinator (e.g., the first AP MLD (112)). Additionally, UL data generated at the non-AP MLD (102) can also be distributed across links 1, 2, and 3 as part of the established multi-link operation. All UL data transmitted over these links will be directed to the CCE (502) and aggregated at the upper UMAC (502A) layer of the CCE (502).

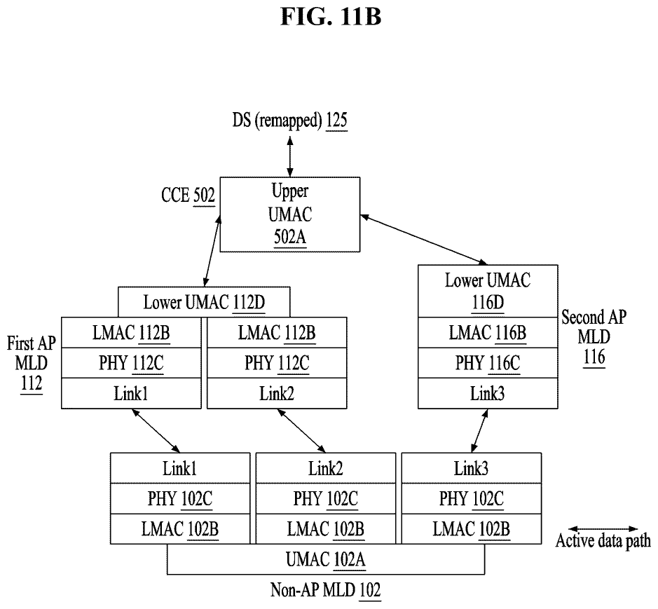

FIG. 12 is a flow diagram that illustrates a method for managing connections between the non-AP MLD (102) and the plurality of AP MLDs according to an embodiment as disclosed herein. In an embodiment, the method illustrated in FIG. 12 is performed by a non-AP MLD (102), a first AP MLD (112), and a second AP MLD (122) as described with reference to FIGS. 2-5. In an embodiment, the method includes steps (1202-1220). Each step is explained in further detail below. Although one or more steps are described or shown in particular sequential order, in other embodiments the operations may be rearranged in a different order, which may include performance of multiple operations in at least partially overlapping time periods.

At step (1202), the non-AP MLD (102) establishes a connection with one or more of the first AP MLD (112) and the second AP MLD (122) in a multi-link mode—e.g., the non-AP MLD (102) established a connection with a first network apparatus in multi-link mode. In an embodiment, the multi-link mode allows the non-AP MLD (102) to transmit and receive data over several frequency bands at the same time, thereby enhancing the overall bandwidth. In this mode, the non-AP MLD (102) can duly choose the optimal link(s) for communication by considering various factors, including interference, congestion, signal quality, and latency needs. By utilizing multiple links, the non-AP MLD (102) can attain greater total throughput, facilitating quicker data transmission and minimizing delays.

At step (1204), the non-AP MLD (102) determines whether one or more key performance indicators (KPIs) of the connection between the non-AP MLD (102) and the first AP MLD (112) indicate the connection is degraded. A degraded connection refers to a network link or communication pathway that is performing below its optimal level. In an embodiment, the network link performing below its optimal level can have a considerable effect on the user experience. In one example, the one or more KPIs for determining/identifying the degradation can include an expected throughput, a reliability, a latency, a jitter, packet error rates, retransmissions, a signal strength, quality, or an interference associated with the connection between the non-AP MLD (102) and one or more of the first AP MLD (112) and the second AP MLD (122).

In an embodiment, the expected throughput indicates the actual data transfer rate occurring between the non-AP MLD (102) and the secondary network device. Reliability pertains to the connection's capacity to sustain stable and error-free communication. In some embodiments, latency is defined as a duration required for data packets to travel to and from the non-AP MLD (102) and the secondary network device, often measured in milliseconds (ms). Jitter represents the fluctuations in latency over time, which can impact the performance of real-time applications. The packet error rate signifies the proportion of data packets that are not transmitted accurately, resulting in either loss or the need for retransmission. Retransmissions refer to the count of data packets that must be sent again due to errors or loss. Signal strength indicates the power level of the received signal, typically measured in decibel-milliwatts (dBM). In an embodiment, signal quality encompasses an overall integrity of the wireless signal, which is affected by interference, noise, and signal strength. Additionally, interference involves various external factors that can disrupt the wireless signal, including competing devices, physical barriers, or ambient noise.

At step (1206), the non-AP MLD (102) determines one or more of a first AP MLD (112) and a second AP MLD (122) for establishing an active data session with, when the connection is degraded. In an embodiment, the active data session denotes a real-time communication exchange in which data packets are sent between the non-AP MLD (102) and one or more of the first AP MLD (112) and the second AP MLD (122). In some embodiments, the active data session utilizes multiple links concurrently to facilitate data transfer. In some embodiments, the connection stays active as long as there is ongoing traffic, by utilizing features such as link aggregation and redundancy to ensure optimal performance.

At step (1208), the non-AP MLD (102) generates an enhanced ML Reconfiguration Request to be transmitted to the first AP MLD (112). In some embodiments, the enhanced ML Reconfiguration Request (ML Reconfiguration* Request) includes information about the plurality of links to be reconfigured for providing an inter AP-MLD multi-connectivity with the second AP MLD (122). Inter AP-MLD multi-connectivity is a capability that allows the non-AP MLD (102) to create and sustain multiple connections with both the first AP MLD (112) and the second AP MLD (122). In some embodiments, the inter AP-MLD multi-connectivity feature facilitates the effective distribution of data traffic between the first AP MLD (112) and the second AP MLD (122). Such embodiments can lead to increased data rates and reduced latency.

At step (1210), the non-AP MLD (102) receives an enhanced ML Reconfiguration Response (ML Reconfiguration* Response) from the first AP MLD (112). The enhanced ML Reconfiguration Response includes at least one link to be reconfigured for providing the inter AP-MLD multi-connectivity with the second AP MLD (122).

At step (1212), the non-AP MLD (102) establishes the active data session between the non-AP MLD (102) and the determined one or more of the first AP MLD (112) and the second AP MLD (122), in a data aggregation mode. In some embodiments, the data aggregation mode is a networking approach that involves a consolidation of smaller data units, such as packets or frames, into a larger single unit for transmission across the network. This technique is frequently employed to enhance network efficiency by minimizing the overhead linked to the transmission of individual data packets. As a result, it boosts overall throughput and decreases latency.

At step (1214), the non-AP MLD (102) establishes the active data session between the non-AP MLD (102) and the first AP MLD (112) on a first link and a second link of the plurality of links.

At step (1216), the active data session can also be extended between the non-AP MLD (102) and both the first AP MLD (112) and the second AP MLD (122) on the first link, the second link, and a third link of the plurality of links. In the active data session, the first AP MLD (112) is a primary coordinator that signals and establishes a data path with the non-AP MLD (102), and the second AP MLD (122) is a secondary coordinator that establishes the data path with the non-AP MLD (102).

In some embodiments, the primary coordinator is tasked with overseeing the signaling processes and establishing a dependable data path with the non-AP MLD (102). This signaling encompasses an exchange of control messages that are crucial for setting up and maintaining the communication link, thereby ensuring efficient and effective data transmission between devices. In some embodiments, the secondary coordinator concentrates on developing a data path with the non-AP MLD (102). Although it does not partake in the broader signaling duties managed by the primary coordinator, the secondary coordinator ensures the establishment and upkeep of the data path, thus supporting the overall data session. The collaboration between the primary and secondary coordinators optimizes data flow and improves network performance.

At step (1218), the non-AP MLD (102) establishes the active data session between the non-AP MLD (102) and the first AP MLD (112) on the first link and the second link of the plurality of links. At step (1220), the non-AP MLD (102) extends the active data session between the second AP MLD (122) on the third link of the plurality of links.

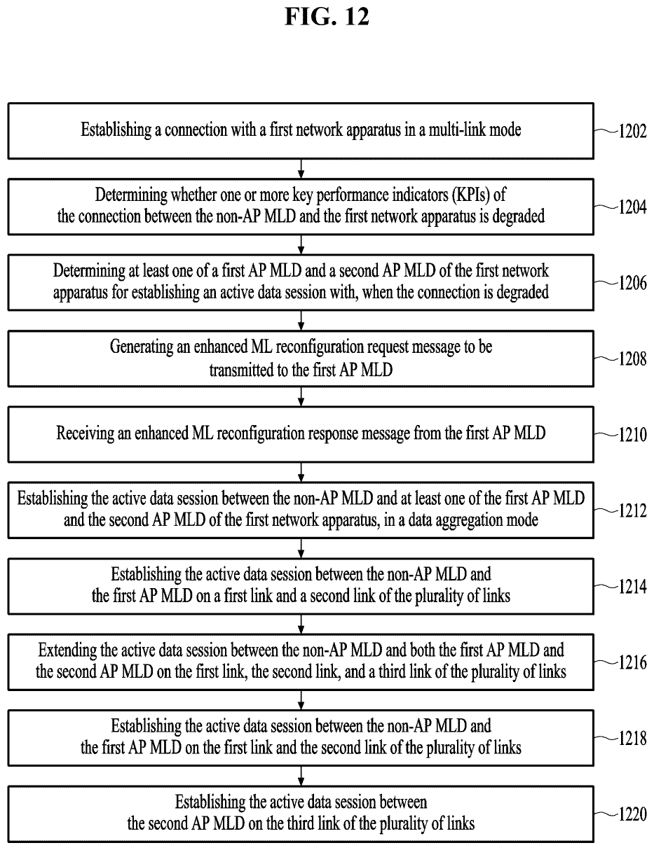

FIG. 13 is a flow diagram that illustrates a method for managing connections between the non-AP MLD (102) and the first AP MLD (112) of the plurality of AP MLDs according to an embodiment as disclosed herein. In an embodiment, the method illustrated in FIG. 13 is performed by a non-AP MLD (102), a first AP MLD (112), and a second AP MLD (122) as described with reference to FIGS. 2-5. In an embodiment, the method includes steps (1302-1310). Each step is explained in further detail below. Although one or more steps are described or shown in particular sequential order, in other embodiments the operations may be rearranged in a different order, which may include performance of multiple operations in at least partially overlapping time periods.

At step (1302), the first AP MLD (112) generates a link admission request to be transmitted to a second AP MLD (122) of the plurality of AP MLDs. In an embodiment, the link admission request includes information about a plurality of links to be reconfigured with the second AP MLD (122) based on one or more conditions. For instance, the one or more conditions include relocation of bad performing active links between the first AP MLD (112) and the second AP MLD (122), addition of new links between the non-AP (102) MLD and the second AP MLD (122), or activation of new links between non-AP MLD (102) and the second AP MLD (122).

In one embodiment, one condition relates to a reassignment of underperforming active links currently linked to the first AP MLD (112). In that, link that fail to meet performance standards, will be transferred to the second AP MLD (122) to improve overall network efficiency and reliability. Such embodiments aim to optimize resource distribution and enhance the quality of service for users connected to the network. In addition to relocating existing links, the link admission request also creates new links between the non-AP MLD (102) and the second AP MLD (122). In some embodiments, establishment of the new links increases a network's capacity and improves communication pathways, thereby boosting overall performance and responsiveness. Furthermore, the link admission request includes the activation of additional links between the non-AP MLD (102) and the second AP MLD (122). In some embodiments, link activation enhances the network's redundancy and resilience, ensuring multiple pathways for data transmission. Consequently, the network can maintain connectivity even in cases of link failures or performance issues.

In an embodiment, the link admission request also encompasses non-AP MLD (102) data session context, which includes elements such as sequence number (SN), packet number (PN) for each traffic-flow identifier (TID), block-acknowledgment agreement (BA), security keys, or similar data. In an embodiment, the SN serves to uniquely identify a particular data packet within a series of transmitted frames, ensuring that the receiver can accurately reconstruct the data in the correct sequence, even if the frames are received out of order. In some instances, the PN acts as a unique identifier for each packet sent across the network, monitored according to TID. In one example, the TID is utilized to classify traffic flows, with each TID corresponding to a specific type of traffic (such as voice, video, or data) and aligning with a quality of service (QOS) level. In such examples, the TIDs facilitate the management of multi-user environments by enabling the network to prioritize different types of traffic. In an embodiment, the BA involves a negotiation process between the non-AP MLD (102) and either the first AP MLD (112) or the second AP MLD (122) to facilitate the acknowledgment of multiple frames in a single response, rather than addressing each frame individually. By using the BA, overhead in the wireless network is minimized, leading to enhanced throughput and efficiency. Additionally, the security keys serve as cryptographic tools that safeguard wireless communications between the non-AP MLD (102) and the first or second AP MLD (112 or 116), ensuring that the data remains confidential, authenticated, and protected against tampering.

At step (1304), the first AP MLD (112) receives a link admission response from the second AP MLD (122). The link admission response includes information about whether an active data session can be established between the non-AP MLD (102) and the second AP MLD (122) on at least one link of the plurality of links indicated in the link admission request.

At step (1306), the first AP MLD (112) establishes the active data session between the non-AP MLD (102) and one or more of the first AP MLD (112) and the second AP MLD (122) on at least one link of the plurality of links.

For establishing the active data session, at step (1308), the first AP MLD (112) generates an enhanced ML Reconfiguration message to be transmitted to the non-AP MLD (102). The enhanced ML Reconfiguration message includes the information about whether the active data session can be established on at least one link of the plurality of links.

Upon generation of the enhanced ML Reconfiguration message, at step (1310), the first AP MLD (112) receives an enhanced ML Reconfiguration Complete message from the non-AP MLD (102). In at least one embodiment, the first AP MLD (112) receives the enhanced ML Reconfiguration Complete message after acknowledgement that the active data session is established on at least one link of the plurality of links.

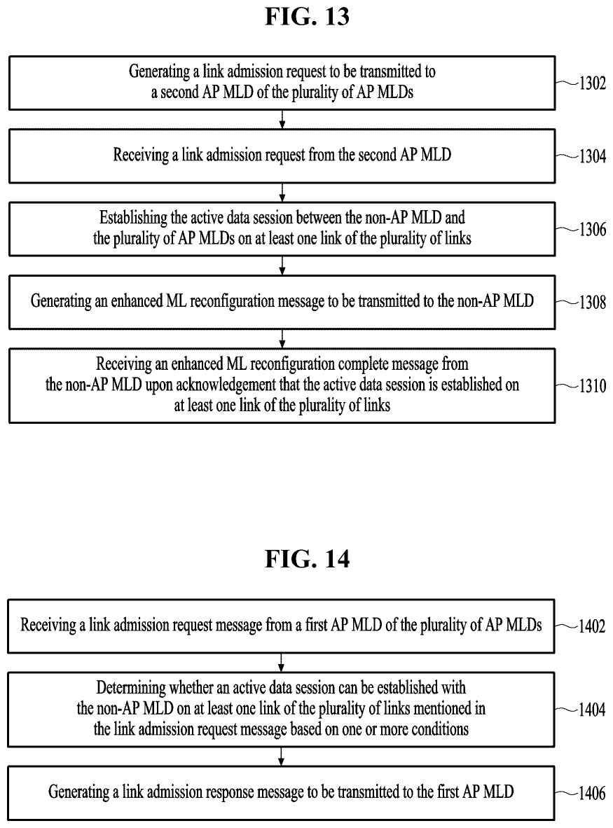

FIG. 14 is a flow diagram that illustrates a method for managing connections between the non-AP MLD (102) and the second AP MLD (122) of the plurality of AP MLDs according to an embodiment as disclosed herein. In an embodiment, the method illustrated in FIG. 14 is performed by a non-AP MLD (102), a first AP MLD (112), and a second AP MLD (122) as described with reference to FIGS. 2-5. In an embodiment, the method includes steps (1402-1406). Each step is explained in further detail below. Although one or more steps are described or shown in particular sequential order, in other embodiments the operations may be rearranged in a different order, which may include performance of multiple operations in at least partially overlapping time periods.

At step (1402), the second AP MLD (122) receives a link admission request from a first AP MLD (112). The link admission request includes information about a plurality of links to be reconfigured with the second AP MLD (122). At step (1404), the second AP MLD (122) determines whether an active data session can be established with the non-AP MLD (102) on at least one link of the plurality of links mentioned in the link admission request based on one or more conditions. The link admission request details the particular links that the first AP MLD (112) intends to alter or create to improve connectivity and performance. This evaluation relies on a series of established criteria, which can encompass elements such as network capacity, link quality, current traffic loads, and similar factors.

At step (1406), the second AP MLD (122) generates a link admission response to be transmitted to the first AP MLD (112). In an embodiment, the link admission response contains details regarding one or more of the multiple links that can facilitate an active data session between the non-AP MLD (102) and the various AP MLDs. In some embodiments, the link admission response offers insights into a status of the requested links. In particular, it specifies which link or links from the initial request can successfully support an active data session between the non-AP MLD (102) and the involved AP MLDs during the communication process.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

A phrase “one or more of” preceding a series of times, with the terms “and” or “or” to separate any of the times, modifies the list as a whole, rather than each member of the list. The phrase “one or more of” does not require a selection of least one item, rather, the phrase allows a meaning that includes one or more of any one of the items, and/or one or more of any combination o the items, and/or one or more of each of the items. By way of example, each of the phrases “as least one of A, B, and C” or “at least of A, B, or C” refers to Only A, only B, only C, any combination of A, B, and C, and/or at least each of A, B, and C

1. A non-access point (AP) multi-link device (MLD) in a wireless network, comprising:
at least one processor including processing circuitry, and
memory storing instructions that, when executed by the at least one processor individually or collectively, cause the non-AP MLD to:
establish a connection with one or more of a first AP MLD and a second AP MLD in a multi-link mode;
determine whether one or more key performance indicators (KPIs) of the connection between the non-AP MLD and the first AP MLD indicate the connection is degraded, wherein the connection comprises a plurality of links;
determine one or more of the first AP MLD and the second AP MLD for establishing an active data session with when the connection is degraded; and
establish the active data session between the non-AP MLD and the determined one or more of the first AP MLD and the second AP MLD, in a data aggregation mode.

2. The non-AP MLD of claim 1, wherein the one or more KPIs comprise one or more of an expected throughput, a reliability, a latency, a jitter, packet error rates, retransmissions, a signal strength, quality, or an interference associated with the connection between the non-AP MLD and one or more of the first AP MLD and the second AP MLD.

3. The non-AP MLD of claim 1, wherein the determining one or more of the first AP MLD and the second AP MLD for establishing the active data session with when the connection is degraded comprises:
generating an enhanced ML Reconfiguration Request to be transmitted to the first AP MLD, wherein the enhanced ML Reconfiguration Request comprises information about the plurality of links to be reconfigured for providing an inter AP-MLD multi-connectivity with the second AP MLD; and
receiving an enhanced ML Reconfiguration Response message from the first AP MLD, wherein the enhanced ML Reconfiguration Response comprises at least one link of the plurality of links to be reconfigured for providing the inter AP-MLD multi-connectivity with the second AP MLD.

4. The non-AP MLD of claim 3, wherein the establishing the active data session between the non-AP MLD and the determined one or more of the first AP MLD and the second AP MLD comprises:
establishing the active data session between the non-AP MLD and the first AP MLD on a first link and a second link of the plurality of links; or
extending the active data session between the non-AP MLD and both the first AP MLD and the second AP MLD on the first link, the second link, and a third link of the plurality of links.

5. The non-AP MLD of claim 4, wherein during the active data session, the first AP MLD is a primary coordinator that signals and establishes a data path with the non-AP MLD, and the second AP MLD is a secondary coordinator that establishes the data path with the non-AP MLD.

6. The non-AP MLD of claim 4, wherein the extending the active data session between the non-AP MLD and both the first AP MLD and the second AP MLD on the first link, the second link, and the third link of the plurality of links comprises:
establishing the active data session between the non-AP MLD and the first AP MLD on the first link and the second link of the plurality of links; or
extending the active data session between the second AP MLD on the third link of the plurality of links.

7. A method for managing connections between a non-access point (AP) multi-link device (MLD) and a plurality of AP MLDs, comprising:
establishing, by the non-AP MLD, a connection with one or more of a first AP MLD and a second AP MLD in a multi-link mode;
determining, by the non-AP MLD, whether one or more key performance indicators (KPIs) of the connection between the non-AP MLD and the first AP MLD indicate the connection is degraded, wherein the connection comprises a plurality of links;
determining, by the non-AP MLD, one or more of a first AP MLD and a second AP MLD for establishing an active data session with when the connection is degraded; and
establishing, by the non-AP MLD, the active data session between the non-AP MLD and the determined one or more of the first AP MLD and the second AP MLD, in a data aggregation mode.

8. The method of claim 7, wherein the one or more KPIs comprise one or more of an expected throughput, a reliability, a latency, a jitter, packet error rates, retransmissions, a signal strength, quality, or an interference associated with the connection between the non-AP MLD and one or both of the first AP MLD and the second AP MLD.

9. The method of claim 7, wherein the determining, by the non-AP MLD, one or more of the first AP MLD and the second AP MLD for establishing the active data session with when the connection is degraded comprises:
generating, by the non-AP MLD, an enhanced ML Reconfiguration Request to be transmitted to the first AP MLD, wherein the enhanced ML Reconfiguration Request comprises information about the plurality of links to be reconfigured for providing an inter AP-MLD multi-connectivity with the second AP MLD; and
receiving, by the non-AP MLD, an enhanced ML Reconfiguration Response message from the first AP MLD, wherein the enhanced ML Reconfiguration Response comprises at least one link of the plurality of links to be reconfigured for providing the inter AP-MLD multi-connectivity with the second AP MLD.

10. The method of claim 9, wherein the establishing, by the non-AP MLD, the active data session between the non-AP MLD and one or more of the first AP MLD and the second AP MLD comprises:
performing, by the non-AP MLD:
establishing, by the non-AP MLD, the active data session between the non-AP MLD and the first AP MLD on a first link and a second link of the plurality of links; or
extending, by the non-AP MLD, the active data session between the non-AP MLD and both the first AP MLD and the second AP MLD on the first link, the second link, and a third link of the plurality of links.

11. The method of claim 10, wherein during the active data session, the first AP MLD is a primary coordinator that signals and establishes a data path with the non-AP MLD, and the second AP MLD is a secondary coordinator that establishes the data path with the non-AP MLD.

12. The method of claim 10, wherein the extending, by the non-AP MLD, the active data session between the non-AP MLD and both the first AP MLD and the second AP MLD on the first link, the second link, and the third link of the plurality of links comprises:
performing, by the non-AP MLD:
establishing, by the non-AP MLD, the active data session between the non-AP MLD and the first AP MLD on the first link and the second link of the plurality of links; or
extending, by the non-AP MLD, the active data session between the second AP MLD on the third link of the plurality of links.

13. A method for managing connections between a non-access point (AP) multi-link device (MLD) and a plurality of AP MLDs, comprising:
generating, by a first AP MLD of the plurality of AP MLDs, a link admission request to be transmitted to a second AP MLD of the plurality of AP MLDs, wherein the link admission request comprises information about a plurality of links to be reconfigured with the second AP MLD based on one or more conditions;
receiving, by the first AP MLD, a link admission response from the second AP MLD, wherein the link admission response comprises information about whether an active data session can be established between the non-AP MLD and the second AP MLD of the plurality of AP MLDs on at least one link of the plurality of links; and
establishing, by the first AP MLD, the active data session between the non-AP MLD and the plurality of AP MLDs on the at least one link of the plurality of links.

14. The method of claim 13, wherein the one or more conditions comprises one or more of a relocation of bad performing active links between the first AP MLD and the second AP MLD, addition of new links between the non-AP MLD and the second AP MLD, or activation of new links between non-AP MLD and the second AP MLD.

15. The method of claim 13, wherein the link admission request comprises non-AP MLD data session context including sequence number (SN), packet number (PN) per traffic-flow identifier (TID), block-acknowledgment agreement (BA), or security keys.

16. The method of claim 13, wherein the establishing, by the first AP MLD, the active data session between the non-AP MLD and the plurality of AP MLDs on at least one link of the plurality of links comprises:
generating, by the first AP MLD, an enhanced ML Reconfiguration message to be transmitted to the non-AP MLD, wherein the enhanced ML Reconfiguration message comprises the information about whether the active data session can be established on at least one link of the plurality of links; and
receiving, by the first AP MLD, an enhanced ML Reconfiguration Complete message from the non-AP MLD upon acknowledgement that the active data session is established on at least one link of the plurality of links.

17. The method of claim 13, comprising:
splitting, by an upper medium access control (UMAC) layer of the first AP MLD, a plurality of data packets received from a backend distribution system (DS) (125) upon establishment of the active data session between the non-AP MLD and one or more of the first AP MLD and the second AP MLD to obtain a first split portion and a second split portion, for downlink data aggregation for uplink data;
performing, by the first AP MLD:
transmitting, by lower media access control (LMAC) layers of the first AP MLD, data packets present in the first split portion to the non-AP MLD on a first link and a second link of the plurality of links; or
forwarding, by the UMAC layer of the first AP MLD, data packets present in the second split portion to the second AP MLD on a third link of the plurality of links via a common control entity (CCE) to be transmitted by the second AP MLD towards the non-AP MLD.

18. The method of claim 13, comprising:
splitting, by an upper medium access control (UMAC) layer of a common control entity (CCE) of the plurality of AP MLDs, the plurality of data packets received from the backend DS upon establishment of the active data session between the non-AP MLD and one or more of the first AP MLD and the second AP MLD to obtain a first portion and a second portion, for downlink data aggregation of uplink data; and
transmitting, by the upper UMAC layer of the CCE, data packets present in the first portion to a lower UMAC layer of the first AP MLD on the first link and second link of the plurality of links, and data packets present in the second portion to a lower UMAC layer of the second AP MLD on the third link of the plurality of links,
wherein a common upper UMAC functionality resides at the CCE and a lower UMAC functionality resides at each of the first AP MLD and the second AP MLD respectively.
